(19) United States
(12) Patent Application Publication
(10) Pub. No.: US 2016/0042621 A1
(43) Pub. Date: Feb. 11, 2016

(54) Video Motion Detection Method and Alert Management

(71) Applicants: William Daylesford Hogg, Toronto (CA); Troy Allan Gutjahr, Carrollton, TX (US)

(72) Inventors: William Daylesford Hogg, Toronto (CA); Troy Allan Gutjahr, Carrollton, TX (US)

(21) Appl. No.: 14/738,889

(22) Filed: Jun. 14, 2015

Related U.S. Application Data
(60) Provisional application No. 62/011,676, filed on Jun. 13, 2014.

(51) Int. Cl. G08B 13/196; G06K 9/00; G06T 7/20; H04N 5/232

(52) U.S. Cl. CPC G08B 13/19604; H04N 5/23229; G06K 9/00771; G06T 7/20; G06T 2207/10016; G06T 2207/30232

(57) ABSTRACT

This invention describes a method and apparatus for security monitoring with a video camera. A mathematical model consisting of an array of cells, or learning map, is used to describe the motion of any object(s) detected by the camera. When an object(s) is detected, its positional location(s) for a period of time, or motion event, is recorded in a learning map. This learning map is then compared to a reference learning map where the camera determines whether to alert the user or not that an object of interest was detected. After viewing the video of the motion event, the user provides feedback that impacts how the reference learning map is updated by information in the motion event learning map. Through this user feedback mechanism, the camera learns to more accurately determine whether or not to alert the user about future motion events, thus reducing the number of false alarms.

### CROSS-REFERENCE TO RELATED APPLICATIONS

Provisional patent: Video Motion Detection Method and Alert Management Filed: 2014 Jun. 13, EFS ID: 19296984, Application No. 62/011,676

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates to the field of video monitoring. More particularly, the present invention relates to a method and apparatus of motion detection analysis and method of alerting users. More particularly, the present invention relates to a learning methodology whereby a user observing a detected motion instructs the system on how to respond to similar detected motions in the future.

### BACKGROUND OF THE INVENTION

Electronic security systems date back to the 1850s where electrical switches mounted on doors and windows were wired to a remote electromechanical buzzer. A number of buzzers, one for each home or business, were then monitored by a human operator in a centralized location. While present day security alarms now use digital electronics, wireless radios, motion and glass break sensors; the heart of the system is still the basic open/close door and window switch. Similarly, alarm monitoring centers haven't changed much with human operators watching over computer screens and taking action when a sensor is tripped and an alarm is triggered.

Recently, home monitoring cameras have started to be used to allow homeowners to remotely check in on their home through a web browser, smart phone or tablet app that shows both live and recorded video. Most security companies have also started to market monitoring cameras to homeowners; however they don't monitor these cameras themselves or typically even have access to the video feeds. While privacy concerns are a major issue, each monitor center has thousands of customers and cannot possibly visually monitor multiple camera video feeds for each customer. They would also have no way of knowing who should be in your home and when.

The majority of home monitoring cameras on the market today incorporate pixel-based motion detection as a standard feature. When a predetermined number of pixels change colour, the user is alerted that a motion has been detected. Some refinements including manually masking off regions of view to ignore or only trigger on. However despite these improvements, motion detection with consumer grade cameras still generate far too many false alarms to be useful and as a result this feature is typically not used.

The present invention describes a method and apparatus for video monitoring and motion detection that can learn what to alert the user about and what to ignore and potentially replace traditional security alarm systems. The described apparatus uses relatively low cost hardware and software suitable for applications such as the consumer home monitoring and security market.

### SUMMARY OF THE INVENTION

The present invention is a method and apparatus for a video monitoring and motion detection system. This invention describes a method where moving object(s) are detected using a monitoring camera with a video analytics processor that generates a description of the detected moving object(s) in the camera's field of view. Preferentially, the video analytics processor generates at a minimum a description of the size and position of the detected object(s) in the camera's field of view once per video frame. A continuous series of detected motions are then grouped together in to a single motion event with the descriptions of detected object(s) from individual video frames summarized in to one motion event description. This motion event description is then analyzed against a motion detection reference. Based on this analysis, a number of actions are then taken including for example: doing nothing, recording the associated video clip and/or notifying the user.

When the user is notified that a motion event has been detected, the user would then view the video clip associated with that motion event and based on that observation, choose one of several responses including but not limited to: doing nothing, instructing the camera to ignore all motion events for a period of time or instructing the camera to update its motion detection reference based on this new event. If the user instructs the camera to update its motion detection reference based on this motion event, the camera would then learn to respond to future similar motion events by comparing the new motion event description with the updated motion detection reference. Through this iterative process, the camera system refines its ability to respond to new motion events in a manner that the individual user desires. This in turn greatly reduces the number of alerts or false alarms the user must address.

This invention further describes a preferential method of describing a detected moving object(s)'s position and size in the camera's field of view for each video frame in terms of an array of elements with each element mapping to a position in the field of view. Each element in turn containing a number of variables that can be used to describe the object(s) detected at that position. A motion event description would then preferentially contain a summation or grouping of the array of elements of one per video frame in to preferentially a single array of elements that describes the entire motion event.

This invention then further describes a preferential method of comparing the description of a motion event in terms of an array of elements with a motion detection reference that is also comprised of an array of elements that similarly matches to the camera's field of view. This invention then describes methodologies to perform the comparison of the motion event array of elements description with the motion detection reference array of elements description.

This invention then describes a methodology of actions to take based on the comparison of the motion event with the motion detection reference. This invention then further describes a methodology to determine whether or not to alert the user about the existence of a detected motion event. When a user is alerted about a motion event, this invention describes a series of steps and options for the user to respond to after viewing the video clip associated with the motion event. This invention then describes a methodology for updating the motion detection reference array with information from the motion event array based on the user's response. The array of elements from a future motion event is then compared to this updated motion detection reference array.

### BRIEF DESCRIPTION OF THE DRAWINGS

FIG. 1 is an image frame taken from a video of a motion event from a monitoring camera, following a method according to the present invention.

FIG. 2 is a graphical representation of a two dimensional learning map of 32×18 cells as described in a preferred embodiment of the present invention.

FIG. 3A is a portion of one video frame from a video referenced in FIG. 1 of a moving object that was detected and described by a white rectangular overlay, following a method according to the present invention.

FIG. 3B is a graphical representation of a portion of a learning map spatially aligned with the camera's field of view shown in FIG. 3A where the white rectangle representation of the moving object in FIG. 3A has been overlaid, following a method according to the present invention.

FIG. 3C is the portion of the learning map in FIG. 3B with cells overlapped by the bottom edge of the white rectangular overlay of the detected object in FIG. 3B marked by an ‘x’, following a method according to the present invention.

FIG. 3D is a portion of one frame from a video referenced in FIG. 1 take at a later time than shown in FIG. 3A of a moving object that was detected and described by a white rectangular overlay, following a method according to the present invention.

FIG. 3E is a graphical representation of a portion of a learning map spatially aligned with the camera's field of view shown in FIG. 3D where the white rectangle representation of the moving object in FIG. 3D has been overlaid, following a method according to the present invention.

FIG. 3F is the portion of the learning map in FIG. 3E with cells overlapped by the bottom edge of the white rectangular overlay of the detected object in FIG. 3E marked by an ‘x’, following a method according to the present invention.

FIG. 4 is a graphical representation of a learning map of a motion event referenced in FIG. 1, following a method according to the present invention.

FIG. 5 is an image frame from a monitoring camera.

FIG. 6 is a graphical representation of a learning map with spatial coordinates aligned to a camera with a field of view of shown in FIG. 5 after being updated and marked for a vehicle passing by following a method according to the present invention.

FIG. 7 is the motion event learning map shown FIG. 6 after being modified with the lowest marked cell in each column replaced with an ‘H’ following a method according to the present invention.

FIG. 8 is the motion event learning map shown in FIG. 7 after being modified with all cells in each column above those cells marked with an ‘H’ marked with a ‘#’ in each cell following a method according to the present invention.

FIG. 9 is a graphical representation of a master learning map with spatial coordinates aligned to a camera with a field of view shown in FIG. 5 following a method according to the present invention.

FIG. 10 is a graphical representation of a weighted master learning map with spatial coordinates aligned to a camera with a field of view shown in FIG. 1 after updating for the motion event learning map shown in FIG. 4, where the value of each cell in the weighted master learning map has been increased by a value of one where its corresponding cell in the motion event learning map had an ‘x’ value following a method according to the present invention.

FIG. 11 is the weighted master learning map shown in FIG. 10 after updating with a second motion event learning map where a person walking up took a slightly different route than shown in FIG. 4 and each cell in the weighted master learning map was increased by adding a second value of one, following a method according to the present invention.

FIG. 12 is the weighted master learning map in FIG. 11 after updating it with a third motion event learning map where a person walking up took yet another slightly different route than shown in FIG. 4 and each weighted master learning map cell was increased by adding a value of one, following a method according to the present invention.

FIG. 13 is a graphical representation of a weighted master learning map using an automated approach to assigning weight values after a single motion event illustrated in FIG. 4, following a method according to the present invention.

FIG. 14A is a graphical representation of a portion of a motion event learning map of someone walking up the pathway similar to the camera's field of view shown FIG. 1, following a method according to the present invention.

FIG. 14B is a graphical representation of a portion of a weighted master learning map for a camera with the same field of view and alignment as shown in FIG. 14A, following a method according to the present invention.

FIG. 14C is a graphical representation of a portion of the motion event learning map from FIG. 14A with weightings applied from the weighted master learning map shown in FIG. 14B, following a method according to the present invention.

FIG. 15A is a graphical representation of a portion of the motion event learning map from FIG. 14C, where the first cell determined to have a zero value was marked with an ‘X’ value and the second cell determined to have a zero value was marked with a ‘Y’ value, following a method according to the present invention.

FIG. 15B is a graphical representation of a portion of the motion event learning map from FIG. 15A illustrating the cell marked with an ‘X’ from FIG. 15A and the surrounding eight cells with any cells marked with a ‘.’ replaced by a value of zero, following a method according to the present invention.

FIG. 15C is a graphical representation of a portion of the motion event learning map from FIG. 15A illustrating the cell marked with a ‘Y’ from FIG. 15A and the surrounding eight cells with any cells marked with a ‘.’ replaced by a value of zero, following a method according to the present invention.

FIG. 16A is an image frame from a motion event video of a vehicle, moving at an angle to the camera and video analytics processor's frame of reference, being detected and described by a white rectangular overlay using metadata from a video analytics processor, following a method according to the present invention.

FIG. 16B is the image frame shown in FIG. 16A with a white overlay rectangle description 162 of a moving vehicle incorrectly indicating the vehicle being on the lawn as indicated by the white triangular region 163.

FIG. 16C is a graphical representation of the master learning map that would correctly be generated for a camera with a field of view shown in FIG. 16A, following a method according to the present invention.

FIG. 16D is a graphical representation of a motion event learning map that results from traditional analysis of vehicle passing at an angle to the camera and video analytics processor's frame of reference as shown in FIG. 16B, following a method according to the present invention.

FIG. 16E is a graphical representation of a motion event learning map that results from dynamic analysis of a vehicle passing at an angle to the camera and video analytics processor's frame of reference using the leading lower corner of the moving object as shown in FIG. 16B, following a method according to the present invention.

FIG. 17 is a graphical representation of a pendulum learning map resulting from analysis of trees and branches swaying in the camera's field of view as illustrated in FIG. 1, following a method according to the present invention.

FIG. 18 is an image frame from a monitoring camera where the same moving object is shown to have three different apparent sizes based on where it is located in the image frame, following a method according to the present invention.

FIG. 19 is a graphical representation of a small object learning map resulting from the analysis of a small object moving around in the camera's field of view as illustrated in FIG. 18, following a method according to the present invention.

FIG. 20 is a flow chart of a preferred embodiment of the function of the motion event handler, following a method according to the present invention.

FIG. 21 is a flow chart of a preferred embodiment of the function of the notification queue handler, following a method according to the present invention.

FIG. 22 is a chart of a preferred embodiment of the options available to the user after viewing a video clip from a motion event, following a method according to the present invention.

### DETAILED DESCRIPTION OF THE INVENTION

### A. Video Camera and Analytics Processing

The present invention makes use of a video camera, which generally is any device with a lens and photo sensor array or similar that can capture and transmit a video signal or stream of picture images.

For the purpose for this invention, a video analytics processor is specialized software that may also include specialized hardware, designed to analyze sequential frames in a video stream and quantify changes in the image from video frame to video frame. In a preferred embodiment of this invention, this processing is performed using specialized software running on a video Digital Signal Processor or DSP semiconductor integrated in to the camera. In alternate embodiments, video analytics processing may be carried out on a general computing platform or DSP processor in the camera, computing platform or DSP processor separate from the camera, computing platform or DSP processor in a cloud computing service, on an app or software program running on a computing platform such as a phone, tablet, laptop, desktop, server or mainframe computer, or through a web based interface.

Part of the functionality of the video analytics processor is to analyze video from the camera and detect the movement of objects from frame to frame within the camera's field of view. The video analytics processor then generates a description of any moving objects detected. In a preferred embodiment of this invention, the video analytics processor generates a data set describing objects detected in each frame of a video in a synchronized manner such that objects described by the video analytics processor can be associated with the video frame from which it was generated. The generated data about moving objects detected in the video frame is often referred to as metadata or data derived from data, which in this case is the video. In a preferred embodiment of this invention, the video analytics processor operates in real or near real-time, such that metadata about moving objects in the video is generated in step with the video. As a result, streaming metadata from the video analytics processor is synchronized with the streaming video from the camera. Note that in an alternate embodiment of this invention, video analytics processing can also be processed at a slower rate than the video is generated or as a batch process after the video has been generated and recorded.

Analysis of information generated by the video analytics processor is carried out using a software program or app running on a computing platform. In a preferred embodiment of this invention, this processing is carried using software running on an embedded ARM processor integrated in the camera. This analysis can also be carried out in multiple parts or whole on a separate general purpose computing platform within the camera, on a computing platform separate from the camera, on a cloud computing service, in an app or program running on a computing platform such as a phone, tablet, laptop, desktop, mainframe computer or server, or through a web based interface.

For the purposes of describing this invention, the term moving object or object is used to describe an object that has been detected in the camera's field of view. This invention anticipates that video analytics processing capability will continue to evolve and that objects will not necessarily be required to be moving or in motion for determination that an object is present. In an alternate embodiment of this invention, detection of an object may be based on, but not limited to, its colour, temperature, texture, shape, identifying features, or position in two or three dimensional space. For example, the detection of facial features alone or in conjunction with with a temperature higher than ambient would be sufficient to determine a person was in the field of view even if motion was not detected. Similarly, the detection of an object may be determined by using other techniques such as using range finding techniques similar, but not limited to, radar or ultrasound or through triangulation with multiple cameras.

For the purposes of describing this invention, the term camera will include a device with a lens and photo sensor array or similar that can capture and transmit a video signal or stream of picture images, as well as include a video analytics processor, whether integrated within the camera or separate, and a software program to analyze information from the video analytics processor running on a computing platform, whether integrated within the camera or separate. In a preferred embodiment of this invention, the camera will also have a means to remotely connect to it through a Local Access Network or LAN using a wired connection such as Ethernet or through a wireless connection such as Wi-Fi, Bluetooth or similar. In an alternate embodiment, the camera can also connect directly or indirectly to a Wide Area Network or WAN through a satellite, cellular phone or data radio connection. In another preferred embodiment of this invention, the camera will also be connected to the Internet through a LAN, cellular radio or similar connection. The Texas Instruments DMVA2 SoC or System on a Chip video processor with embedded video, video analytics and ARM processors is an example of hardware available to construct a camera as described in one of the preferred embodiments of this invention.

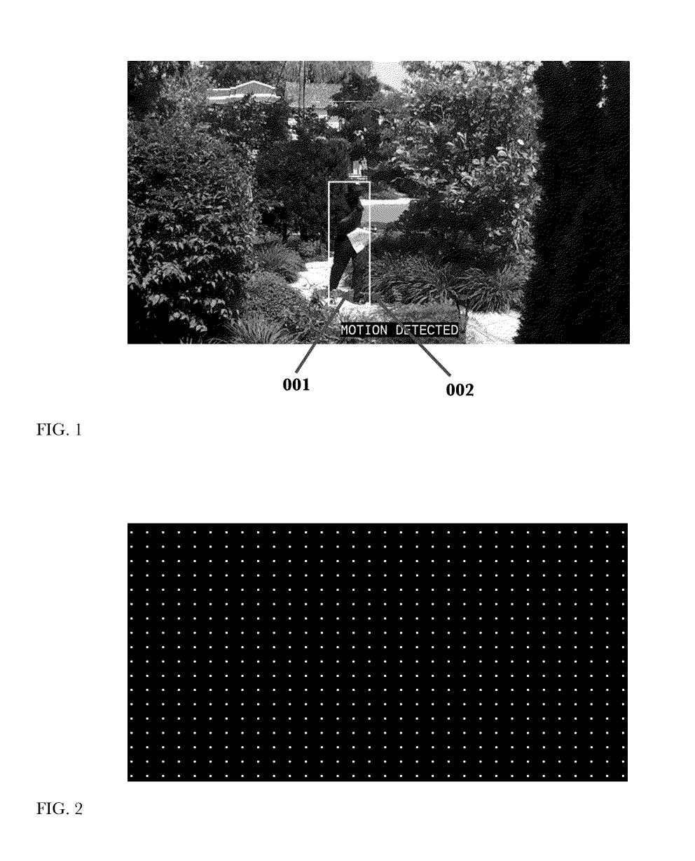

FIG. 1 illustrates an example of an image or single video frame captured from a video clip from a camera as described above. In this example, video from the camera was processed through a video analytics processor that detects the presence of moving object(s) within the field of view of the camera. When moving object(s) are detected, the video analytics processor generates a description of the object(s) detected creating metadata about that video. One example of metadata generated by the video analytics processor, but not limited to, is the size and position of any moving object(s) detected. In the example in FIG. 1, a delivery person 001 has been detected moving across the field of view of the camera by the video analytics processor and metadata has been generated that describes the delivery person as an object in terms of a rectangular box with width and height located at a specific location in the camera's field of view. This metadata is then illustrated in the image in FIG. 1 by a white rectangle outline 002 using the height, width and x,y location position description of the object as determined by the video analytics processor. In a preferred embodiment of the invention, for each successive video frame, the video analytics processor determines the movement of object(s) and generates a new description of those object(s) as streaming metadata synchronized with the streaming video images.

The example shown in FIG. 1 of an object being detected with its size and position determined and illustrated is one example of the information generated from a basic video analytics processor. This invention also anticipates that other more or less advanced video processors could be used that provide a more detailed description of objects detected including properties such as but not limited to speed, velocity, acceleration, colour, temperature, texture, or position in the third axis if a 3D camera were used. Additional information generated by the video analytics processor could also include a more accurate object size description using more advanced mathematical descriptions than a rectangle including, but not limited to, multisided polygon, multiple multisided polygons, fractal representations, pixel by pixel outline or other advanced mathematical or graphical representations. Additional informational descriptors envisioned by this patent include, but not limited to, identification of the object as a bipedal animal, such as a human, four legged animal, such as a dog, and a moving vehicle with rotating wheels, such as an automobile. Additional information descriptors about detected objects also envisioned by this patent include, but not limited to its overall shape, texture, or the existence of facial features, such as eyes, nose or mouth.

It is also envisioned in the present patent, that additional information relate to the overall image scene may also be determined, recorded and analyzed such as, but not limited to, the time of day, date, season, sun location, moon location, weather, temperature, overall scene luminosity, location details, GPS coordinates, camera facing direction, camera hardware and software information, as well as information about other cameras and sensors in the same area.

### B. Motion Event

For the purpose of this invention, a motion event is defined as period of time corresponding to the detection of one or more moving objects in the camera's field of view. In one embodiment of this invention, the start of a motion event occurs when a moving object is first detected. In another embodiment of this invention, the beginning of a motion event will occur before a moving object is detected. In a preferred embodiment of this invention, a camera with built in video buffer memory is utilized. When motion is detected, the camera retrieves recorded video from the video buffer memory of the scene for a period of time (for example three seconds) before a moving object is detected and includes this video segment as part of the motion event recording. This preferred embodiment has the advantage of capturing a video recording of the scene with potentially some initial object motion not significant enough for the video analytics processor to determine that an object motion has occurred, but still of interest to the user.

When a motion event occurs, a preferred embodiment of this invention has the camera making a recording of the streaming video and associated metadata generated by the camera for the period of the motion event, as well as other information generated by the camera and associating them together under a common motion event record. In a preferred embodiment, a predefined time period is used for each motion event, for example ten to fifteen seconds. In an alternate embodiment, a longer or shorter fixed time period for each motion event could also be used as well as an indefinite time period whose length or decision to end the motion event is determined by another factor such as, but not limited to, the absence of detected motion.

A motion event need not involve a specific recording being made. One alternate embodiment of this invention envisions video and metadata continuously being recorded in the camera or on a separate computing device locally, remotely or on a cloud service. A motion event would then consist of a time stamp or similar marker, which points to a period of the recorded video and metadata where motion was detected.

Another embodiment of this invention does not require that motion events be treated as discrete events. Instead, analysis may be carried out continuously with feedback and updating of the motion event analysis algorithms carried out as an independent function or activity from what is being detected.

In another embodiment of this invention, the length of each motion event is determined by the presence of stationary object that was previously moving in the field of view. For example, the length of a motion event would be defined by the ongoing presence of an object of a particular colour or other attribute not necessarily defined by its motion. For example a person with a red shirt walking in to the field of view would trigger a motion event. In this embodiment, the camera would continue to record the motion event even when the person stood still as long as a defining feature of the object, in this case the colour of the shirt, remains in place. This invention envisions a predetermined maximum period of time for a motion event would be used when recording the presence of previously moving stationary objects.

In another embodiment of this invention, the start and end of a motion event is determined by other factors or triggers, including but not limited to motion detected in another camera, a motion event in another camera, other sensors such as door or window open sensor, another trigger, or user input through a human-machine interface.

In a preferred embodiment, a short finite time is used for each motion event. If moving object(s) continue to be detected at the end of a motion event, a new motion event is triggered with its corresponding recorded video clip, metadata file and other associated data. As long as moving object(s) are being detected in the field of view, a new motion event will be generated with corresponding recordings of video clips, metadata and other data.

### C. Learning Map

This invention anticipates that video standards will continue to evolve and that depending of the application, higher or lower resolution video may be employed. For the purpose of explanation of this invention the standard 720p HD or High Definition resolution video source, which is 1,280 pixels horizontally by 720 pixels vertically, will be used for examples. A typical HD video analytics processor determines the position of object(s) moving within the field of view with a lower resolution that the video source being analyzed. For example, a typical HD video analytics processor would analyze the field of view with a resolution of 320 pixels horizontally by 180 pixels vertically, or a resolution one quarter that of the source HD video image being analyzed. Using a resolution that is an integer multiple (four in this example) of the source video greatly reduces the processing required and hence cost of the video analytics processor. This invention anticipates that like video standards, video analytics processor technology will also evolve and that processors with lower, equal or higher resolution than that of the source video may be advantageous.

In an embodiment of this invention, the video analytics processor analyzes each video frame and any object(s) detected are described by a box with its lower left x and y position, plus width and height given in terms of coordinates of the video analytics processor's resolution, which in this example would be 320×180 units. The reference frame used by the video analytics processor also matches the source video or is spatially aligned. In this example each cell or pixel from the video analytics processor would thus map to a section of the source video image that is 4 pixels wide by 4 pixels high.

Depending on the video analytics processor being used, for example, 15 or more objects can be identified and tracked in each image frame. The coordinates for each rectangular box that describes each moving object detected in each frame of video comprises part of the associated metadata being generated by the video analytics processor. In FIG. 1, the delivery person 001 was detected as one moving object and characterized by a rectangular outline in the corresponding video analytics processor metadata. To illustrate the dimensions of the objects detected, a white rectangular outline 002 is superimposed on the video image using metadata from the video analytics processor to visually relate the object being detected in each video frame and described in the metadata to the source video.

In an embodiment of this invention, a learning map is defined as an array or grid of cells as illustrated in FIG. 2. In a preferred embodiment, the learning map is a two dimensional array of cells with each array cell comprised of, but not limited to, a single value, an array of set of values, or an indeterminate or changing data record. FIG. 2 illustrates one graphical representation of a learning map with each cell represented by a dot or ‘.’ in the figure. It should be noted that any character or number could be used in place of a dot or ‘.’ in depicting the learning map graphically. Each cell corresponds to an area in the camera's field of view or image. Similar to the video analytics processor using a resolution of one quarter that of the image resolution that the data is generated from, in this preferred embodiment, the learning map uses a resolution less than or equal to that used by the video analytics processor. For example, a video stream with an HD resolution of 1280×720 pixels is preferentially analyzed by a video analytics processor with exactly one quarter of the video resolution or 320×180. In one embodiment of this invention, metadata from the video analytics processor from a motion event would then be analyzed using a learning map with an integer divisor of 1:4 that of the video analytics processor resolution resulting in a learning map with resolution of 80×45 cells. The learning map example shown in FIG. 2 uses a grid with dimensions of 32×18, which is 1/10 the resolution of the HD video analytics processor and 1/40 the resolution of the HD video source. Thus in the example shown in FIG. 2, each cell on the learning map corresponds to a portion of the video analytics processor output array that is 10×10 units, which in turn corresponds to a portion of the video image that is 40 image pixels high by 40 image pixels wide, with each cell in the learning map spatially aligned with the video analytics processor grid, which is in turn spatially aligned with the source video image's field of view. While using integer resolution multiples is not a requirement of this invention, it is advantageous as it reduces the processing required by limiting calculations to integer arithmetic instead of for example real or floating point number arithmetic. Similarly, using a learning map resolution less than the source video is not a requirement of this invention, but greatly reduces numerical computation required. As a result, processing with the learning map may be carried out using an inexpensive computing platform such as an embedded ARM processor collocated with a video image processor within a monitoring camera. This invention anticipates that using multi-dimensional learning maps or multiple learning maps may also be advantageous. This invention also anticipates that advances in computational processing will enable the implementation of greater learning map resolutions and more complex mathematical operations and relationships.

It is important to note that the learning map is described as a two dimensional array of values denoted by an alphanumeric character for visual representation. Implementation of the algorithm to generate and analyze the learning map does not require adherence to a two dimensional data model structure as long as the mathematical mapping relationship between the learning map and coordinates of the video analytics processor and in turn the source video is maintained. Similarly, each value or cell in the array need not be a single scalar value, but can be an array of values itself or a record with indeterminate or changing data structure.

In a preferred embodiment of this invention, when an object is detected to have moved within the field of view of the camera, a motion event is triggered and the event recorded. Information retained in a motion event record includes, but is not limited to, a video clip of the event including pre-event video buffer, associated metadata generated by the video analytics processor for this time period as well as additional information such as the time and date of the video recording. After the motion event is finished and has been recorded, a motion event learning map is generated. A motion event learning map is defined as a learning map generated from information contained in a motion event recording. In a preferred embodiment, a unique motion event learning map is generated from each motion event and associated with other information in that motion event record. Waiting for a motion event to be completed before generating a learning map is not a requirement of this invention and the process may be started while the motion event is still ongoing.

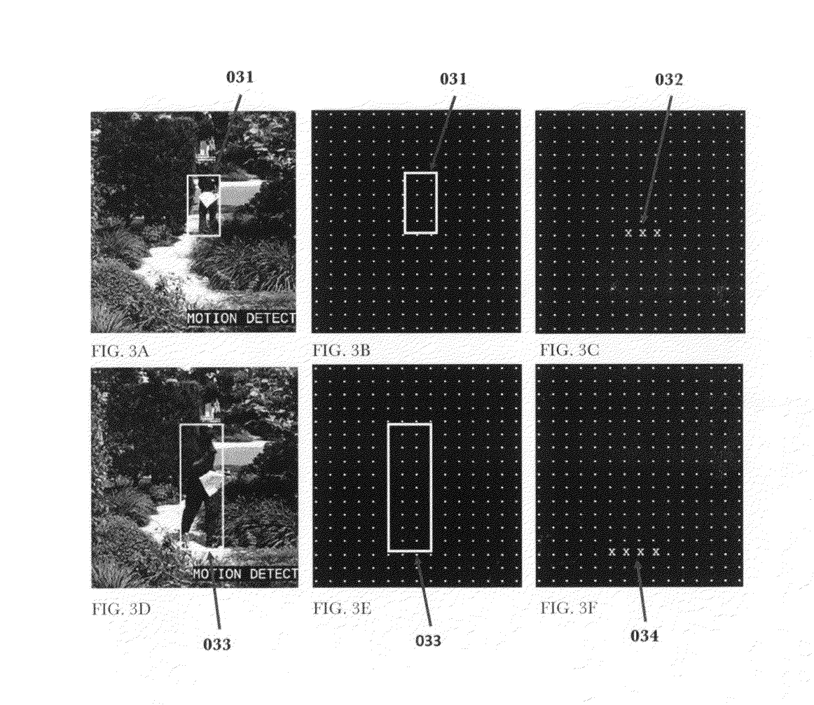

FIG. 3A illustrates a portion of the video frame taken from the video frame shown in FIG. 1. The video analytics processor determined that an object had moved in to the field of view and generated metadata describing the moving object detected. In FIG. 3A, the position and size of the detected object is shown by a white rectangular outline 031 overlaid on the video frame using the video metadata information. In a preferred embodiment of this invention, the position and size of the detected object in this video frame is then mapped onto the corresponding coordinates of the motion event learning map as shown in FIG. 3B. In this example, the coordinates of the rectangle in the video analytics grid of 320 by 180 pixels are mapped on to the learning map's 32×18 array by dividing the video analytics positional values by ten. The metadata used to describe the moving object as a white outline 031 in FIG. 3A is the same white outline illustrated in FIG. 3B mapped over the corresponding learning map array or grid.

A motion event learning map is then generated by taking metadata from each video frame captured during a motion event and appropriately updating the learning map. For example, a ten second motion event recorded at 15 frames a second would result with a motion event with 150 video frames and 150 sets of metadata, one for each video frame. This invention describes a procedure whereby this large set of data can be reduced down to a single array of data or learning map that describes the entire motion event. This feature has the benefit of greatly reducing the computation required to analyze and describe a motion event and compare it with past motion events. This invention anticipates that a myriad of mechanisms can be implemented to update the learning map from metadata generated from a motion event and is not restricted to any one particular method.

In a preferred embodiment of this invention, the cells of the motion event learning map that coincide with the bottom edge of the moving object detected in the video frame are registered on the learning map. In FIG. 3C three ‘x’s 032 are used to mark and visually identify which three learning map cells coincide with the bottom edge of the rectangle that the video analytics processor generated to describe the moving object in the video frame. In this preferred embodiment, coincided refers to the coordinates of the object described overlapping spatially with cells in the learning map array. This invention anticipates that other criteria and mathematical relationships can be used to determine what constitutes coinciding.

In an alternative embodiment, all learning map cells touched by the rectangle that describes the object could also be marked and additional information about that object added but not limited to its height, texture, colour or speed for later analysis. In yet another embodiment, an alternate form, shape or mathematical description of the object detected may be generated by the video analytics processor. This alternate form may be used in its entirety, part of, projection of or other mathematical relationship to the description to determine what cells to mark on the learning map. In the case of an irregularly shaped object description, one alternate embodiment involves using a vertical projection of the object on to the lowest learning map row touched by the object's description in that video frame. The lowest row touched by the object in a frame would identify how far the object was from the camera while the vertically projected shape on to that row would capture its width or size. Note that in most cases, this approach would yield the same result as a basic rectangular outline as described above. It should also be noted that any character or number could be used in place of an ‘x’ in graphically depicting the learning map.

This invention anticipates that marking a cell in the implementation software algorithm may consist of any value dissimilar to those values in the learning map array that were not coinciding with the metadata that described the moving object(s). This invention also anticipates that each cell in the learning array need not be updated but rather a relationship such as, but not limited to, the equation of a line may be used. The visual illustration used to describe the invention is not intended to describe or limit how the logic would be implemented in a computer software program. In addition to marking the location and size of the detected moving object, additional information such as height, centroid, colour, shape, texture or temperature may also be advantageously recorded in a data structure mapped to each array cell of the learning map.

FIG. 3D illustrates another video frame taken a couple of seconds later in the recorded motion event, from which FIG. 3A was captured. The delivery person has now walked further along the path and is now closer to the camera and appears larger and lower in the video frame. Once again, metadata about the object's position and size is generated as shown by the white outline 033 in FIG. 3D. The position and size of the rectangle describing the moving object is then mapped on to the motion event learning map, as shown by the white rectangular outline 033 in FIG. 3E. Following the preferred embodiment method described above, the learning map cells that coincide with the bottom edge of the rectangle 033 that describes the object are then marked by four ‘x’s 034 as shown in FIG. 3F. Note that addition information obtained from the metadata and any other source could also be used to update the learning map including but not limited to the object's height, texture, colour or speed for later analysis.

In a preferred embodiment of this invention, the above process is performed for each video frame in a motion event with the location of the bottom edge of moving object(s) detected marked in the motion event learning map. While this preferred embodiment describes one motion event learning map being updated for each video frame of the motion event, it may be preferable to utilize multiple learning maps for each motion event. This invention also anticipates that not every video frame need be analyzed within a motion event and that different learning map updating techniques may also be employed. A typical good quality video camera can stream and record up to 15 fps (frames per second) or more, although this invention anticipates that higher or lower frame rates may be preferential. A 10 second motion event video clip recorded at 15 fps would thus have 150 video frames to analyze. In this preferred embodiment, for each video frame, the bottom edges of all object(s) detected are marked in the corresponding motion event learning map cells.

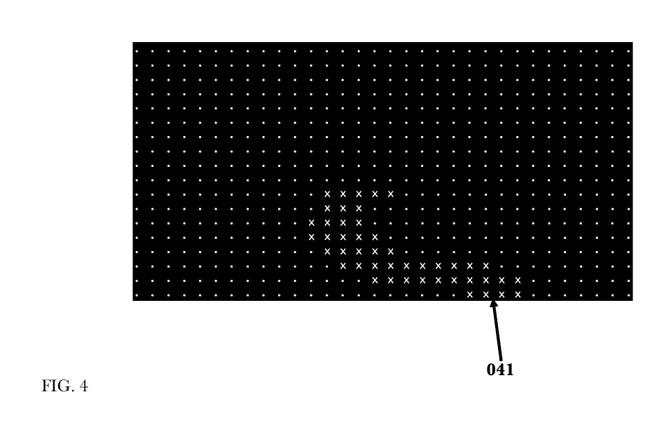

FIG. 4 illustrates a motion event learning map created using the preferential method described above. This learning map was derived from the same ten second motion event used in the examples shown in FIGS. 1 and 3 of a delivery person walking up to the front door of a house. Note that in this particular embodiment of the invention, each cell in the motion event learning map is updated only once, as represented by the ‘x’ 041, no matter how many times an object is detected to be in that location for the duration of that motion event. Once again, information collected in the motion event learning map need not be limited to the path taken by the object but may also include its speed, velocity, acceleration, apparent size, temperature, texture and colour at different locations on the motion event learning map.

In a preferred embodiment, after every video frame from a motion event is analyzed and the motion event learning map is generated, the motion event learning map data is recorded and associated with the video clip, metadata and other information from that motion event.

In an alternate embodiment of this invention, the number of video frames or time an object was detected to be in a location is also recorded. Thus each cell in the motion event learning map would have a number recorded in it that is associated with the number of video frames an object was detected in that location. In a preferred embodiment, video is recorded at a constant frame rate, such as 15 frames per second. Thus the number of frames an object was detected to be at a certain position would also be a measure of the duration of time spent at that location. For example, an object detected to be at one location for 5 video frames would have been at that location for ⅓ of a second assuming a constant video frame rate of 15 frames per second.

### D. Master Learning Map

In an embodiment of this invention, a mechanism is used to accumulate information from past motion events, which is then used to analyze or compare information from a new motion event and determine a course of action from that analysis.

In a preferred embodiment of this invention, a master learning map is a learning map used to accumulate information from past motion events that can then be used to analyze or compare information from a new motion event and determine a course of action from that analysis.

In a preferred embodiment, the master learning map has the same dimensions as motion event learning maps and is used to accumulate or create a reference for subsequent motion events to be analyzed against. This invention also anticipates that the master learning map may have different dimensions than the motion event learning map or that more than one master learning map may be utilized. The master learning map may also have a different data structure for each array cell than that used for the motion event learning map.

In the preferred embodiment of this invention, the learning map is used to record characteristics of any moving object(s) detected within the field of view of the camera, thus the master learning map is only relevant to that particular camera and its field of view. Similarly, only motion event learning maps from the same camera and field of view can be used to compare against and update a master learning map. However, this invention anticipates that there can be more than one master learning map per camera and they can be selectively updated by motion event learning maps. This invention also anticipates that other cameras with overlapping fields of view could be used to update another camera's master learning map.

In one preferred embodiment, multiple users have access to a camera, each with their own personal or shared master learning map. Similarly, each user may also have an individualized response to analysis carried out against their own or shared master learning maps. For example, a homeowner may want to be notified whenever someone walks up the front pathway, while a security company may only want to be notified when someone walks off the pathway. When a person walks up the front pathway, a motion event is triggered and a motion event learning map is generated. The motion event learning map would then be compared to the homeowner's master learning map and the security company's master learning map. As a result of previous responses to motion events, the homeowner would be alerted, while the security company would not.

In another embodiment of this invention, additional sources of information may be used to augment information contained in a camera's master learning map or other reference information from which future motion events are analyzed against. In one embodiment, two cameras viewing a scene or part of a scene from different angles or vantage points would yield additional metadata about the detected objects through triangulation of their relative locations in each camera's different field of view. Additional information about detected moving objects may also be determined from additional sensors such as, but not limited to, infrared sensors, pressure sensors, proximity sensors, security sensors, laser scanners or thermal cameras. Additional information about the camera's field of view may also include, but not limited to, it's geographic or GPS coordinates, date, time of day, ambient temperature, and direction the camera is facing. Additional information may also include that directly entered or through an appropriate interface by the user whether general information, through a learning map or other reference information source.

An important embodiment of this invention is the concept that due to the positioning, geometry and optics of a typical camera lens, information about an object's location can be determined by its position in the field of view. Objects closer to the camera will appear lower in the field of view (or camera's image frame) and larger, while objects further away will appear higher in the field of view (or camera image frame) and smaller. A similar but less pronounced effect exists when an object moves from the horizontal center of the field of view to either side of the field of view (or camera image frame). A consequence of this lens geometry is that limited information can be determined from just an object's apparent size. However, if one assumes that most objects of interest being detected move about on the ground or on visible surfaces and are not flying or hovering, then an approximation of a moving object's relative position can then be determined by analyzing the lowest point an object appears in a video frame. An embodiment of this invention is that a reference object moving in the field of view can be used to characterize object motions of interest within the field of view without having specific knowledge of details regarding the field of view, features within it or details on the reference object itself. A preferred embodiment of this invention is that the position of an object in the field of view can determined by the x,y (and third dimension z if available) coordinates of the lowest position of the object in the field of view. This positional information of an object within the field of view can then be used to characterize object motions against the positional information of a known reference object(s) moving in the field of view (or camera image frame).

An embodiment of this invention is that with the exception of flying and hovering objects, there exists a one to one relationship between the lower edge of a detected object and its placement in the scene being captured by the camera's field of view. This relationship allows the description and characterization of moving objects in a specific location in the camera's image frame to be used as a basis for comparison with other objects detected to be moving at that same location in the camera's image frame without specific knowledge of the scene being observed. Hence, an advantageous aspect of this invention is that the camera's monitoring and learning algorithms do not require knowledge of the scene being monitored. One example of this invention's ability to analyze complex scenes is a camera looking out on to a large backyard with a horizontal deck railing near the camera in the middle of its field of view. A squirrel would look relatively small moving about on the backyard lawn as viewed by the camera looking above or below the railing, however that same squirrel would look very large sitting on the railing since it is much closer to the camera than the backyard ground. The preferred embodiment of the methodology of the present invention doesn't attempt to calculate the railing height or distance from the camera, but rather uses the apparent size of an observed object to calibrate apparent object sizes of interest at different positions in the camera's field of view. In this example, a squirrel is used as reference small object and would appear small below or above the railing while moving about in the backyard. However, the squirrel would appear relatively large while sitting on the railing. In this example, where the user would not want to notified if a squirrel or smaller animal were detected moving about, the master learning map would indicate a relatively small (with respect to the overall field of view) maximum object size to be ignored in most regions except for a line across the field of view corresponding to the position of the railing, where a much larger maximum apparent object size would be ignored.

In the case of a flying or hovering object, its apparent size would be overestimated as a function of how high it appeared in the field of view. This may lead to a situation where the user is alerted to small objects such as birds flying near the camera and not being ignored as a small object. While motion events of this nature may trigger unwanted alerts, or false positives, the described invention does not render the camera insensitive to object motions of interest or false negatives.

### E. The Learning Camera

An embodiment of this invention is that when a moving object is detected and a motion event triggered, its nature is characterized and a response determined such that when future similar moving objects are detected, a similar response is enacted. A preferred embodiment of this invention utilizes a human or user to visually observe a recording of a motion event, identify it and specify what action should be taken when similar motion events are detected in the future.

When a motion event is detected, a preferred embodiment of this invention involves a video of the event recorded and a corresponding motion event learning map generated as shown in the example in FIG. 4. In a preferred embodiment of this invention, user(s) of the camera are then notified that a motion event has occurred through any number of means including, but not limited to, an email, app, browser or similar notification, text message, SMS message, messaging platform, social media notification, automated or manual phone call or an audible or visual indicator on the camera, separate device, web page, app or web browser interface. In a preferred embodiment of this invention, the user(s) views the video clip of the motion event and responds to, identifies or characterizes the nature of the motion event detected through an app, web browser interface, program or similar user interface. Through this method, the user provides feedback and the camera learns on how to respond to future similar motion events.

In one embodiment of this invention, the user would have one of two options to respond with following viewing a motion event—‘Delete’ or ‘Learn’. If the user selects ‘Delete’, the motion event, video clip, metadata and motion event learning map are deleted and no further action is taken. If however the user selects ‘Learn’, the information in the motion event learning map and other information and metadata related to that motion event are then used to update the appropriate master learning map(s) and other reference information. When future motion events are detected, the new motion event learning map is compared to the current appropriate master learning map. If for example, the new motion event was due to an object moving in the same area as recorded in the master learning map, the user would not be notified as the camera had learned to ignore motion in that region from previous detected motion events. If the object moved over an area not previously marked on the master learning map, the user would be notified. If after viewing the new motion event video clip, the user selected ‘Learn’, the master learning map would then be updated with the new information from the motion event learning map. Otherwise, selecting ‘Delete’ would delete the motion event as well as associated video, metadata and motion event learning map and no change to the master learning map would result. Thus this simple example illustrates how the camera can learn what to alert the user about based on their feedback from viewing previous motion events.

An alternate embodiment of this invention entails the master learning map being updated for regions to alert the user about, instead of marking off regions to ignore. For example, the user would select ‘learn’ whenever someone or something is detected to be in a region that the user wants to be alerted about. The user would then be alerted by any subsequent movement in that region. This embodiment is effectively the inverse application of the preferred embodiment where the learning map is marked where you want to be notified about motion instead of being marked where you want the camera to ignore motion. While the treatment of the learning map is different, the user would still only be alerted when a motion event occurred in a region where they wanted to be notified about.

In an alternate embodiment of this invention, a different approach to updating the master learning map can be implemented including, but not limited to, allowing the user to manually manipulate cells in the master learning map either directly or through an intermediary user interface. One example being a screen showing a video image and the user being able to draw on the screen regions they want to or do not want to be alerted about when motion is detected to have occurred.

Thus a key embodiment of this invention is a process whereby a motion has occurred, a mathematical description of an object's motion has been created such as, but not limited to, a learning map, a reference of previous motions is compared to the new motion, if the comparison warrants further action the user(s) are notified, having viewed the video of the new motion detected, the user(s) identifies or characterizes the motion in some fashion including no response, the reference of previous motions is then updated based on the nature of the new motion that was detected and the users' response.

### F. Camera Alignment

In a preferred embodiment of this invention, the camera is required to remain in a fixed position maintaining a constant field of view. Anytime the camera is moved or its field of view is changed, the master learning map array will no longer spatially align with the video's image or field of view. Subsequent motion event learning maps cannot then be directly used to update the master learning map. In one embodiment of this invention, small changes in alignment due to vibrations and wind can be compensated for by taking and storing a reference picture or video frame at the time the camera is first initialized. Camera alignment can then be manually or automatically checked by taking a current image frame and comparing it to the previously saved reference frame. The technique of comparing two image frames and quantifying their differences is a well-established technique that can be implemented in this application either in the camera, on a separate computing platform or through a cloud based computational service. If the camera is still aligned, the difference between the original image and the latest image should be minimal. If the camera is out of alignment by a small amount, the reference image can be shifted and compared again. This process can be repeated in the x and y direction until once again a good overlap exists. The adjusted reference image would now become the new reference image and the x and y corrections made to the reference image would then be applied to the master learning map to bring it in alignment with the camera's new position. This alignment can be automatically checked on a regular basis and a record kept of total corrections applied. If the cumulative number, degree or magnitude of corrections exceeds a predetermined amount, the user could be notified that a reset is required to be performed or the camera can simply resets itself if required. If this automatic adjustment fails to determine a correction factor, the camera has been moved by a large amount, or the camera has been moved to an entirely new location, the master learning map would need to be reset and the learning processes started over. Note that this alignment procedure would also apply to the third dimension were a 3D camera to be used. Similarly, this alignment procedure would also be required to be used in the situation where one camera's master learning map also uses information from another camera's master or motion event learning maps.

In a preferred embodiment of this invention, the camera is aligned vertically. An assumption of this preferred embodiment is that the image is being viewed in an upright orientation with the point closest to the camera at the bottom center of the video image and points farthest away, such as the sky, at the top corners of the image. The camera itself can be mounted upside down or on its side, however the image would have to be rotated optically or electronically by the camera before being analyzed by the video analytics processor or rotated before being analyzed using a learning map. A tilt sensor could also be incorporated in the camera to automatically determine what degree of rotation is required.

An alternate embodiment of this invention could use a camera with a different orientation other than vertical if the appropriate corrections were made to the analysis of the video, output from the video analytics processor and learning map analysis.

In a preferred embodiment of this invention, the camera is located on the property being monitored. This enables the use of a horizon or property line object motion identification and prioritization based on the vertical location of an object in the camera's field of view. This is not a requirement of the present invention as it will work when monitoring a location distant from the camera. Similarly, the camera can be used inside a building or shelter where motion outside of the location's property line may not be appropriate.

### G. Pathway and Property Line Motion Events

In the above motion event example when a delivery person was detected from which FIG. 1 was taken, the user had the option of selecting ‘Delete’ or ‘Learn’ after viewing the video from each motion event. Selecting ‘Delete’ simply ignores the motion event, while selecting ‘Learn’ instructs the camera to learn the movement of the object in that motion event and ignore future motions that fall within previous learned motion regions.

In an embodiment of this invention, a mechanism is used to characterize a detected object motion using one or more descriptors, which then forms a reference from which future object motions are compared. When a new object motion is found to be of similar nature to a previous characterized motion, a course of action is taken as previously determined.

In a preferred embodiment of this invention, the user identifies a motion event in such a way that this type of motion can be recognized using a mechanism and handled in a similar manner. In one embodiment, the user would be presented with a number of motion event descriptions that if selected would result in future similar motion events being treated in a similar fashion. In an alternate embodiment, the user could create a user-defined motion event description and then create a corresponding action to be taken when future motion events are determined to be of the type previously defined by the user. In yet another embodiment, one motion event can be described by more than one description or characterization and as a result, subsequent similar motion events would be handled by more than one action response.

In a preferred embodiment of this invention, objects moving on the user's property but in an allowed area or prescribed region such as a walkway or driveway, the user would identify the motion event as such by labeling it, for example, as a ‘Pathway’. The user could then instruct the camera to respond to Pathway motion events in a specific way different from other motion events. One example being that a Pathway motion event could be ignored during daylight hours, but alert the user if someone walks up the walkway at night.

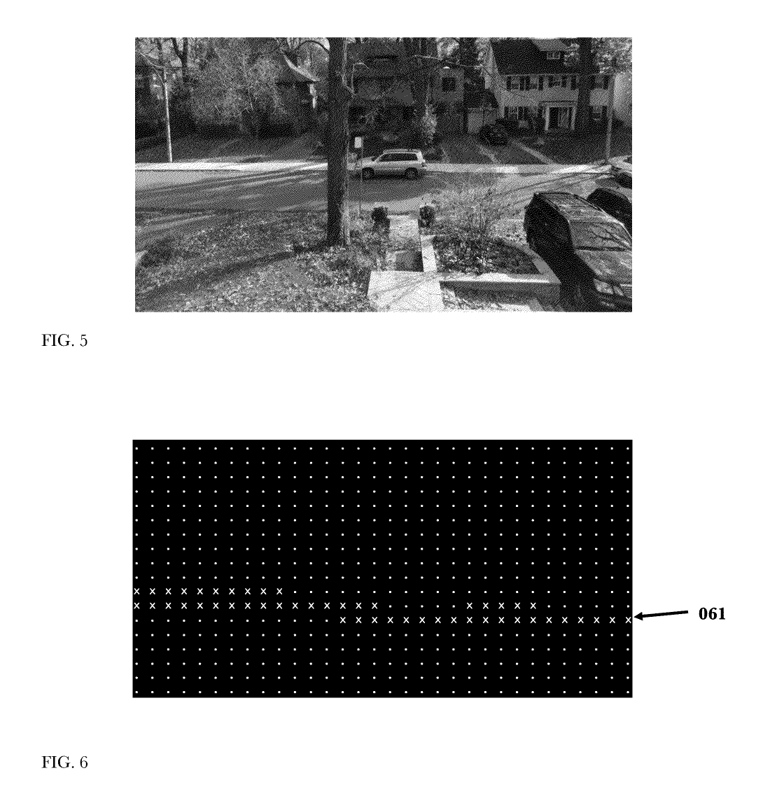

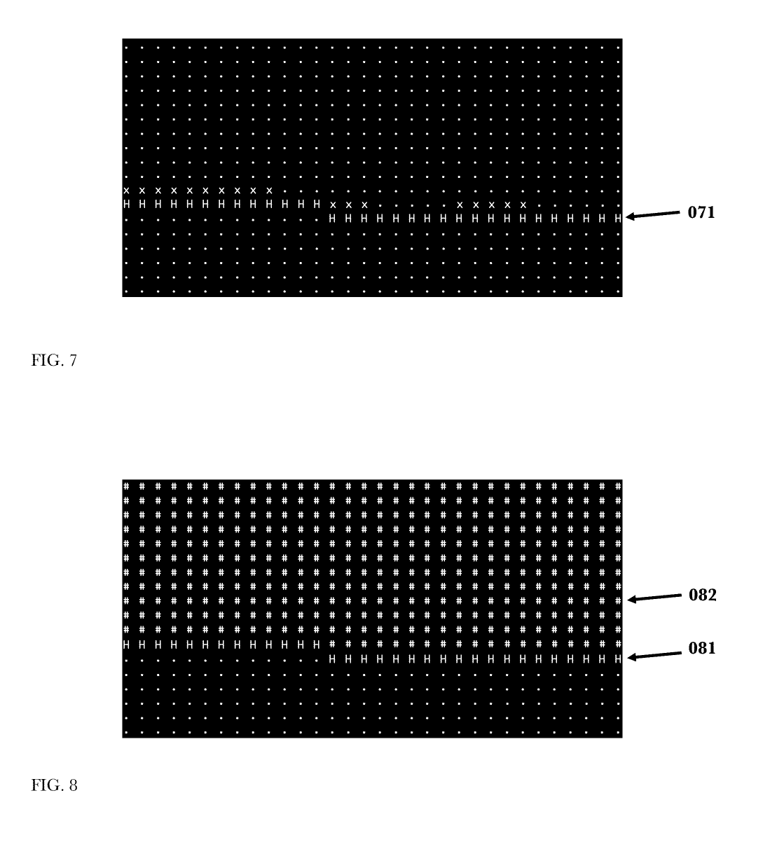

Typically in an outdoor facing application, the user is only interested in being alerted when someone has walked on to their property and not movement on the street or on a neighbor's property. FIG. 5 illustrates the outward view from a typical home. Using the above described approach, a vehicle driving past on the road would trigger a motion event and a motion event learning map would be generated that describes its motion as illustrated in the example in FIG. 6. In this example, a vehicle in each video frame of the motion event would be described by a rectangle with its lower limit at or near the curb of the home being watched from as it drove on the left hand side of the road from left to right. The ‘x’ values 061 in the motion event learning map depicted in FIG. 6 thus represent the bottom edge of the description of the vehicle driving by in the motion event.

When the user to selects ‘Learn’ after viewing the video clip of the motion event where the vehicle was detected driving past on the roadway, the master learning map would then be updated. Any car subsequently driving by in that lane in the exact same fashion would then be correctly identified as not being of interest to the user and the user would not be alerted. However, the camera would still alert the user if a car drove by in the other lane, a pedestrian walked by on the far sidewalk or if a neighbor across the street were to drive up in to their own driveway. In one embodiment of this invention, the user would update the master learning map every time a car or person passed by on or across the street is a fashion that wasn't previously captured. To accelerate the camera's learning process in this situation, the concept of a horizon or property line was developed.

In a preferred embodiment of this invention, after viewing a video from a motion event where motion occurred off the property, such as a car driving by on the street, the user could identify the motion event as having occurred off their property by identifying it as a Property Line motion event through the user interface. In this case, the camera would first create a motion event learning map that describes the path that the vehicle took as it would for any motion event as shown in FIG. 6. When the user identifies the motion event as a Property Line motion event or similar description, a second step is then taken to modify the motion event learning map as shown in FIG. 7. All cells in the motion event learning map along the bottom or lower edge of the path taken by the moving object are first marked as being on the lower limit of the property line as defined by that moving object. As shown in FIG. 7, this is illustrated by an ‘H’ in each learning map cell 071. It should be noted that any character or number could be used in place of an ‘H’ in marking the learning map. As a result of the camera's orientation, optical imaging properties of a lens and the camera's location being on the user's property, all cells above the cells marked ‘H’ would then also not map to being on the user's property. This relationship isn't always the case and exceptions to the rule can be envisioned. However, it is sufficiently common enough that this methodology proves advantageous. Instead of relying on additional motion events to map out more of the area outside of the user's property, a preferential embodiment of this invention entails all motion event learning map cells above the property line or horizon as identified by an ‘H’ in the learning map cell 071 as shown in FIG. 7 automatically marked as being off the property. As shown in FIG. 8, each learning map cell above the horizon or property line marked with an ‘H’ 081 is now marked with the symbol ‘#’ in each cell 082. It should be noted that any character or number could be used in place of am ‘x’, ‘H’, ‘#’ of ‘.’ in marking the learning map. This representation is purely representative and it is envisioned that this methodology may be implemented in any number of ways in a software algorithm.

Once a motion event has been identified by the user as having occurred outside their property or a Property Line motion event, the motion event learning map is updated as shown in FIG. 8. The updated motion event learning map is then used to update the master learning map. When an object, whether car or person, now passes by the house on the street, the resulting motion event learning map would be compared to the master learning map and the camera would determine that the motion occurred off the property or above the property line and thus would not be of interest to the user. Since any area above the property or horizon line has also been marked as outside the property, a neighbor across the street driving their car in to their driveway or even a bird flying by would generate a motion event, but after analysis using the master learning map, the object would be interpreted as moving off the property and the user would not be alerted and that motion event ignored. The above description assumes the user would not want to be informed about movements that occur off their property. This invention anticipates that other use cases may be desirable including notifying the user whenever an object is detected moving off of their property.

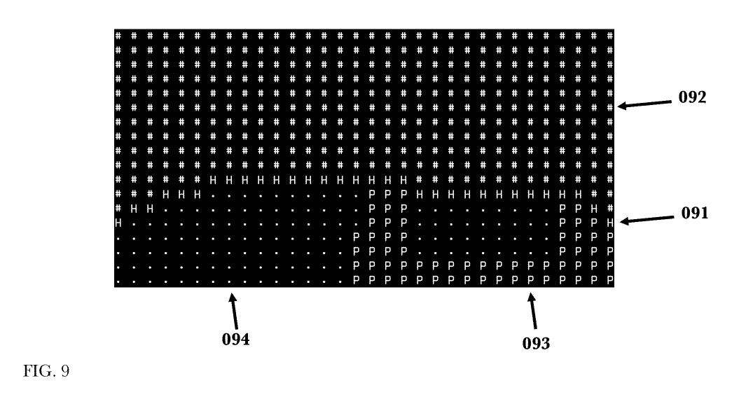

FIG. 9 illustrates an example of a master learning map for the scene shown in FIG. 5 following the camera receiving user feedback from multiple motion events. Cars and people driving along the street and up and down the neighbors' driveway on either side of the user's home were identified as having occurred outside the user's property and marked by ‘H’ 091 with cells above the those marked with an ‘H’ automatically assigned a value of ‘#’ 092 in the master learning map as previously described in this invention. Note the property line of the home is now more accurately reflected in the master learning map after multiple learned motion events.

Pedestrians walking up the home's walkway, along the side path and down the user's own driveway were identified as walking along a Pathway and denoted by a ‘P’ 093 on the master learning map as illustrated in the example in FIG. 9. It should be noted that any character or number could be used in place of a ‘P’ in marking the learning map.

A preferred embodiment of this invention would entail the user setting the camera to respond differently for events outside of their property line, such as ignore all motion events at any time. Motion events occurring along the pathway marked by ‘P’ 093 could then be treated differently, such as being ignored during the day, but alerting the user at night. Motion events occurring in areas not marked as being off the property or on a pathway as illustrated in FIG. 9 by a ‘.’ symbol 094 could then be set to alert the user at any time of the day.

In an alternate embodiment of this invention, the master learning map can be modified by the user either directly or through an alternate user interface. One example being the user manually draws the property line on a screen overlaid on a frame of the video showing the camera's field of view. Similarly, individual master learning map cells could be manually marked by the user or an existing master learning map could also be manually edited by the user.

In a preferred embodiment of this invention, other areas, regions on the master learning map can be marked off as requiring a unique response in the event an object is detected as moving in that area. One example would be marking off an area of the master learning map where an automobile is normally parked. A response, for example, could then be set to alert the user if motion was detected around the automobile during a time period from 12:01 am to 6:00 am.

### H. Binary Master Learning Map

FIG. 4 illustrates a motion event learning map determined from detecting a person walking up the pathway, from which frame image in FIG. 1 was also taken. As previously described, the moving object or delivery person in this example would have been detected to have been moving over any one location multiple times as a result of a camera frame rate of 15 frames per second with each frame of video generating one set of metadata that describes the detected object. As described previously in a preferred embodiment of this invention, each cell in the motion event learning map was marked only once indicating that a motion was detected as having occurred at least once at that location. This invention envisions that other approaches to generating a motion event learning map may also be employed.

At the completion of a motion event, the motion event learning map is generated. A preferred embodiment of this invention has the steps of comparing this learning map with the master learning map. If the decision is made to alert the user, the user would then view the associated video clip and if appropriate, update the master learning map with information from the motion event learning map associated with the video clip observed. This invention envisions that there are many ways that the updating of the master learning map from a motion event learning map may be implemented. Since the learning map is presented as a visual representation tool, the invention also envisions that the algorithm implemented in software may also take on many different forms in part due to the many different forms the learning map information may represented or stored.

In an embodiment of this invention, updating the master learning map with data from a motion event learning map follows the following process. Each array cell in the the master learning map is compared with the spatially corresponding cell in the motion event learning map. If motion was detected in that cell region and the motion event learning map is marked according (illustrated as an ‘x’ 041 in FIG. 4), then the corresponding cell in the master learning map would be updated to indicate that at a minimum some motion was detected in that region. In a preferred embodiment of this invention, each cell in the master learning map is update if motion was detected as well as information that describes the motion as indicated by the user after viewing the corresponding video clip.

To continue this example, when a second person walks up the pathway (using the same example illustrated in FIG. 1), but takes a slightly different route, the resulting second motion event learning map would have a slightly different described path than the first motion event learning map. If the master learning map had only been updated with information from the first motion event learning map, then upon comparison with the second motion event learning map, some additional cells in the master learning map would also be marked as having had motion detected at least once and updated accordingly. The resulting master learning map having been updated twice in this example would then more accurately describe the actual pathway in the camera's image or field of view than was done after just one motion event. As a result, it becomes less likely that someone walking up the path would step on a region not already marked as being on the pathway in the master learning map after each successive learning episode. In this manner, a key embodiment of this invention is demonstrated where the camera improves its detection accuracy by learning from user's responses to viewing additional motion events.

The above method describes the implementation of a binary master learning map where an array cell is marked as motion having been detected at least once. The comparison of a motion event learning map with the master event learning map is then carried out by comparing the value of each array cell in the motion event learning map with the spatially corresponding array cell in the master learning map.

### I. Weighted Master Learning Map

The approach as described thus far works well if, for example, each person that walks up the front pathway stays on main part of the pathway. In practice, some people don't walk down the middle of the path, but instead cut corners. Similarly, someone stepping momentarily on your front lawn to let a car pass would trigger an unwanted notification. In both examples, you would not want to be notified about a minor incursion. However it would also not be desirable to mark off part of the lawn as belonging to the road or pathway. Thus a means is required to determine to what degree a motion event occurred inside an area of interest and respond appropriately. For example, if a person took twenty steps up a pathway and stepped on the lawn once, it would be reasonable to not notify the user since the vast majority of time the person stayed on the walkway as you would prefer.

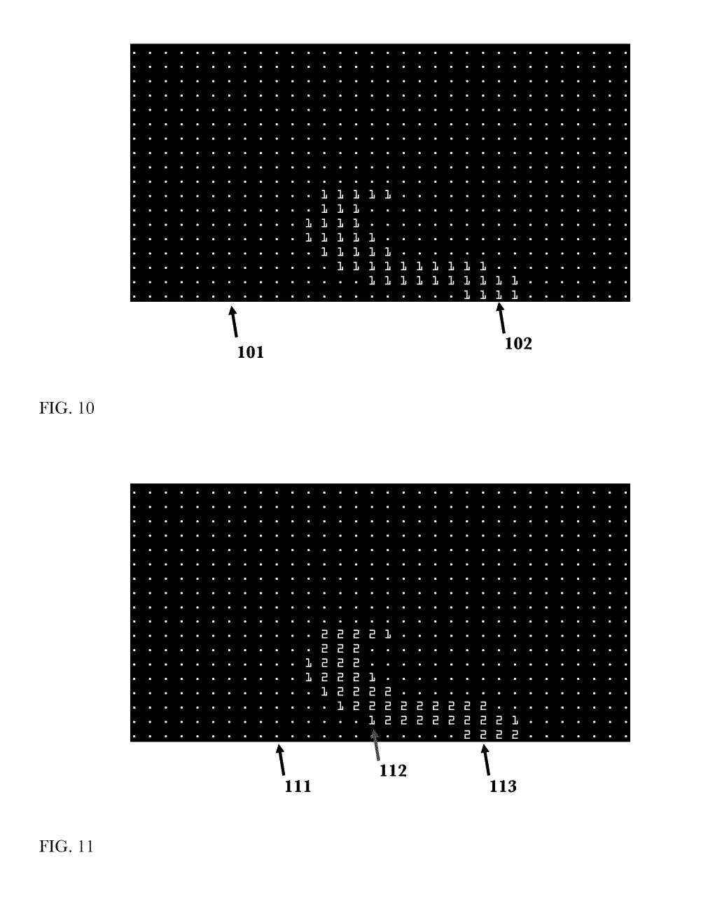

To address this issue, a preferred embodiment of this invention incorporates a master learning map with weightings for each array cell. FIG. 4 illustrates the result of a motion event learning map after one person walks up the pathway. In this embodiment, instead of updating the master learning map from a motion event learning map with a binary ‘x’ for each array cell the person walked on and motion was detected, a value of +1 for example is added to every master learning map array cell where the spatially corresponding array cell in the motion event learning map was marked with an ‘x’. FIG. 10 illustrates a weighted master learning map after being updated for the motion event example shown in FIG. 4. In this embodiment, any cell marked with a ‘.’ 101 in this graphical representation, is treated as having a value of zero. When a second person walks up the front pathway in a slightly different manner and triggers a motion event, a slightly different second motion event learning map is generated reflecting the slightly different route the second person took up the front pathway. After the user identifies the second motion event to be of the same type as the first motion event, the weighted master learning map is updated in the same fashion with a value of +1 being added to each master learning map array cell wherever an ‘x’ is present in the array cell of the spatially corresponding second motion event learning map. FIG. 11 illustrates a weighted master learning map after it is updated for two slightly different motion events of the same type as identified by the user. Array cells marked with an ‘.’ 111 indicate that no motion has been detected. Array cells marked with a ‘1’ 112 indicate that motion has been detected at that location once in either the first or second motion event, while array cells marked with a ‘2’ 113 indicate that motion has been detected at that location in both motion events.

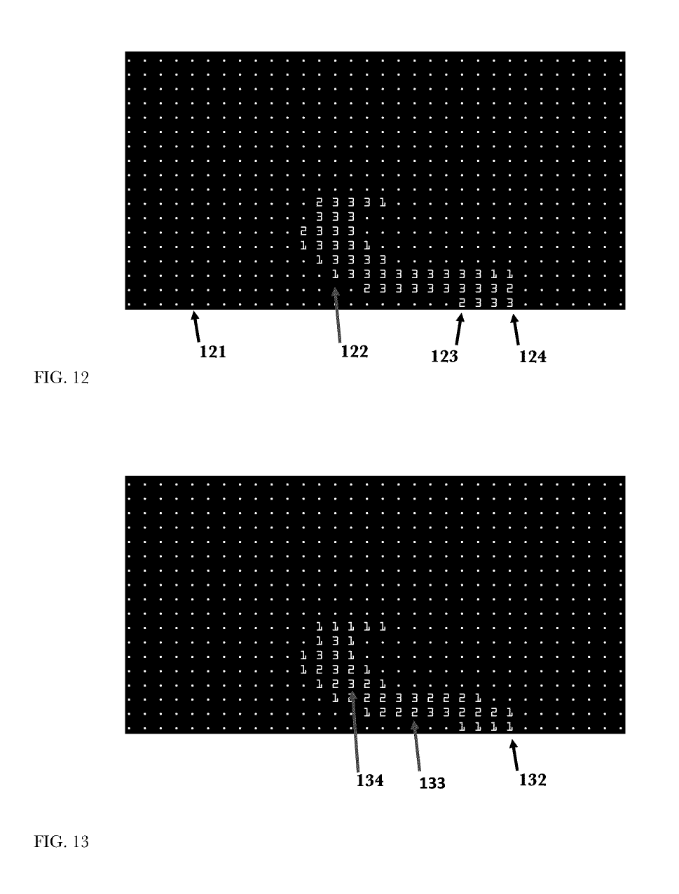

Continuing with this example, when a third person walks up the front pathway and triggers a third motion event, another different motion event learning map is generated reflecting the slightly different route the third person took up the front pathway. After the user identifies the new motion event to be of the same type as the previous two motion events in this example, the master learning map is updated in the same fashion with a value of +1 being added to each master learning map array cell wherever an ‘x’ is present in the corresponding motion event learning map array cell as illustrated in FIG. 12.

The weighted master learning map shown in FIG. 12 illustrates the result of updating it three times for three separate motion events from three events of people walking up the front pathway. In each case, the individuals walked mainly up the center of the pathway but each person deviated slightly at different points along the pathway. Weighted master learning map array cells with a value of ‘3’ 124 indicate that all three people crossed the path at the same point. Array cells marked with a ‘2’ 123 indicate that 2 of the 3 people crossed the path at that point, while array cells marked with a ‘1’ 122 indicate that only one of the three people were detected as moving at that particular point. No motion was detected where array cells are marked with ‘.’.

In an embodiment of this invention, a maximum value for each weighted master learning map array cell is set beforehand. In an alternate embodiment, no limit is set to the value a weighted master learning array cell can be updated to. This invention also envisions that a maximum value could be dynamically determined based on a number of factors including but not limited to timing of updates and information in the weighted master learning map.

In a preferred embodiment of this invention, a motion event learning map array cell marked as having detected motion at that location would be compared to the value in the spatially corresponding weighted master learning map array cell. If the value in the weighted master array cell at that location was above a predetermined threshold level, motion at that location would be identified as being previously recognized and the appropriate action taken. If the value of this array cell is below a threshold level, then based on the users response to viewing of the associated video clip, it may or may not be further updated. This invention envisions that this threshold value may or may not be set the same as the maximum value for the weighted learning map array cells. This invention also envisions that the threshold value could be dynamically determined based on a number of factors including but not limited to timing of updates and information in the weighted master learning map.

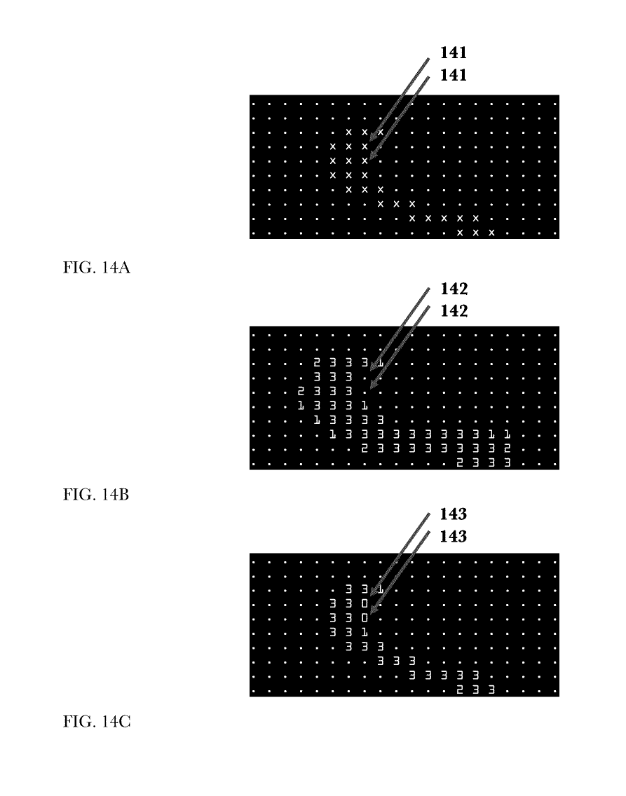

In an alternate embodiment of this invention, weightings for each weighted master learning map array cell may also be automatically generated rather than relying on multiple motion events to generate a distribution of cell weightings. For example, FIG. 13 illustrates an automatically generated weighted master learning map from one motion event of a person walking up a pathway as illustrated in FIG. 1. In this example, a weighting of ‘1’ is be applied to all array cells on the outside edge 132 of an area where motion had been detected, a weighting of ‘3’ to all array cells in the middle 134 of an area where motion had been detected and a weighting of ‘2’ to all array cells in between 133.

In another alternate embodiment of this invention, other factors such as, but not limited to, the time and date of each motion event added to the master learning map may also be recorded and used to modify the master learning map. For example, the age or time passed since a master learning map was last updated may be used to modify the weighting factor on a motion event learning map before being used to update a master learning map. For example, newer motion events may be given greater weightings than older motion events.

In a preferred embodiment of this invention, the weightings or values in the weighted master learning map may be algorithmically modified. For example, the weightings may be systematically reduced based on time elapsed or other factors such as, but not limited to the number and frequency of motion events detected. This preferred embodiment would require the user to view and respond to additional motion events to update the master learning map but would be advantageous as it would ensure the master learning map is current and reflects the user's current preferences.

In another alternate embodiment, motion events may be weighted based on other factors, but not limited to, time of day, daylight versus nighttime, day of the week, month of the year or season when they were recorded and adjusted according to those same measures. For example, a motion event recorded in winter could be assigned a greater weighting during winter months and a lesser weighting during summer months. Similarly, motion events recorded at night could be assigned a greater weighting at night and automatically lowered as dawn approaches, while putting greater weight on other motion events recorded during daylight hours.

In another alternate embodiment of this invention, an additional weighting factor may also be applied based on where on the learning map the array cell is located. For example, if due to the orientation and optics of the camera, array cells at the bottom center of the learning map are closer to the camera than at the top left or top right and motion detected closer to the camera is of more interest than motion further away, a weighting factor proportionate to an array cell's position in the learning map may also be applied.

The above examples describe methods by which weightings in the master learning map may be modified based on updates from new motion events. In another alternate embodiment, prior to comparing a motion event learning map to the master learning map, the weightings on marked cells in the motion event learning map may also be modified. For example, higher weight values could be applied to marked cells closer to the bottom center in the motion event learning map than its upper corners. This would result in greater weight being placed on motion detected closer to the camera.

In another alternate embodiment, the length of time an object is detected moving over a specific location may be used as a weighting factor. When a motion event occurs, the video analytics processor analyses each video frame for movement of an object from the previous video frame. Thus in an alternate embodiment, the motion event learning map may be constructed by adding a value of +1 to each cell where an object was detected moving for each frame of video in a motion event. Since most video cameras record at a constant frame rate, the number of video frames an object was detected over in a motion event learning map would correspond to the length of time the moving object spent near that location. Hence this technique would effectively generate a time duration weighted motion event learning map.

In another alternate embodiment, a time duration weighted motion event learning map is used to generate a time duration weighted master learning map, where values in the motion event learning map are used to update time duration weighted master learning map based on a mechanism determined in part by the response of the user.

In another alternate embodiment of this invention, a time duration weighted motion event learning map is compared to a master learning map, where in addition to where a moving object was detected; the length of time spent in a location generates a different response. For example, a different response may be generated whenever a moving object was detected to be in one region, such as around a car or perimeter of a house, for a length of time greater than a predetermined time, which may or may not be different than other regions in the field of view. A person walking by a car on a driveway or delivering mail would not stay in one spot for a long period of time. However, someone looking in or trying to break into a car or house would spend more time at one location. As a result, a time duration weighted motion event learning map would have higher counts in some cells than expected from normal activity. In an alternate embodiment, different threshold counts for durations of movement anywhere in the field of view, in a user specified region, or on the property as defined by a previously learned property line may also be used to detect when an object is in a region longer than a preferred time. This invention also envisions that other mechanisms for determining thresholds for periods of motion may be determined by, but not limited to, position in the field of view, time of day or other user specified parameters.

In another alternate embodiment of this invention, the weighting of each array cell in the master learning map may also be modified manually through a user interface or by other means.

In another alternate embodiment of this invention, the value updated in a master learning map array cell may be modified as a function of the value of cells surrounding the cell in the motion event learning map and the value of the cells surrounding the cell to be updated in the master learning map.

This invention also anticipates that other learning map weighting approaches and master learning map updating mechanisms may be implemented in addition to the approaches described in the above embodiments and examples. For example, cells could be multiplied by a factor instead of adding a constant each time a motion event learning map is used to update the master learning map.

### J. Learning Map Point Comparison

This invention in part describes a method of describing the detection of an object or motion event in terms of a motion event learning map and a method of describing learned motion events in terms of a master learning map. This invention anticipates that any number of methods may be invoked to compare a motion event learning map with that of a master learning map and base subsequent actions on that comparison.

In an embodiment of this invention, each array cell in the motion event learning map is compared with its corresponding spatially aligned array cell in the master learning map. This comparison may be carried out by a mathematical or similar method and results in a conclusion based on the value(s) in the two cell arrays. For example, motion detected in a region mapped by an array cell that had been previously marked as outside the user's property, would be ignored. In one embodiment of this invention, a motion event would not be acted upon only if all the individual array cell comparisons yield the same result as to not be acted upon. If one array cell comparison yields a result requiring further action, then the entire motion event would be acted upon.

In a further embodiment of this invention, a threshold may be used to determine whether a sufficient number of array cell comparisons, indicating further action is required, has been determined. For example, a threshold of two percent may be set. Thus more than two array cell comparisons, from a motion event learning map where motion was detected in 100 array cells, would be required to initiate further action. This invention anticipates that this threshold method and parameters may be predetermined or algorithmically determined and variable based on any number of factors.

### K. Applying Global Weighted Learning Maps

This invention thus far describes basing a decision to act upon a motion event by comparing individual motion event learning map array cells with that of individual master learning map array cells. This invention also anticipates that a decision to act upon a motion event may also be carried out by analyzing a motion event in its entirety.

In an alternate embodiment of this invention, the decision to act upon a motion event is based on collectively comparing all array cells marked where motion has been detected in a motion event learning map with the corresponding master learning map array cells. For example, FIG. 14A illustrates a portion of a representation of a motion event learning map, with the camera field of view from FIG. 1, where a person cut the corner of the pathway. When compared to a weighted master learning map previously generated for that same camera view, a portion of which is shown in FIG. 14B, two of the 26 marked array cells 141 in the motion event learning map were outside of the marked areas in the master learning map.

Analyzing the array cell comparisons individually would result in action being taken since one cell comparison indicated action was required for what would have otherwise been considered a minor transgression. However, since the person stepped off the pathway, it would also not be desirable for the user to instruct the camera to ignore similar occurrences in the future either.

In an embodiment of this invention, individual array cell comparisons are first made and then the results of those comparisons are tallied. Using the above example, two of 26 or 7.7% of the delivery person's movement was in a region the user wanted to be alerted about. If a threshold of 5% was set, then the motion event would have been acted upon and the user notified once again for a relatively minor incursion.

In an alternate preferential embodiment of this invention, mathematical operation(s) are first performed on array cells where motion was detected, the results of these individual array cell calculations are then summarized by adding together or performing some other mathematical operation to yield a single value, this value is then used to determine whether further action is required. For example, FIG. 14C illustrates the motion event learning map shown in FIG. 14A after the weightings from the master learning map in FIG. 14B have been applied. In this graphical example, each array cell with the character ‘x’ in FIG. 14A is replaced by the value of the corresponding array cell in FIG. 14B as shown in FIG. 14C. In the case where an array cell in FIG. 14B is marked with a null character ‘.’ 142, the corresponding cell is assigned a value of ‘0’ 143, as shown in FIG. 14C. Summing up the values in the array cells in FIG. 14C yields a value of 67, which is a weighted measure of the time the person walked on the walkway. The weighted measure of the time the person walked off the walkway is calculated by adding up the number of array cells that were marked with a ‘0’ 143 shown in FIG. 14C. In this example, the weighted measure of the time the person walked off the walkway is 2. Taking the ratio of time spent off versus on the walkway yields a value of 2/67 or 3.0%. Thus using the same threshold of 5% used in the previous example, would result in no action being taken for a relatively minor incursion. This embodiment is considered to be more advantageous as it deemphasizes a minor transgression or deviation from a previously learned region.

An alternate embodiment to this invention would entail using an actual time weighted motion event learning map to capture actual time spent on an allowed region compared the actual time spent on a region the user wanted to be notified about. This invention also anticipates that the standard or spatial weighted learning map could be combined through some mechanism with an actual time weighted learning map to capture both approaches.

The above methodology describes one mathematical formula or relationship to compare a motion event learning map with a master learning map using weightings applied to different learning map cells. This invention also anticipates that other mathematical formulae or relationships and approaches may be implemented in addition to the above described embodiments and examples.

### L. Applying Local Weighted Learning Maps

The above methodology describes analyzing a motion event as a whole and determining to what degree or percent of the time of the motion event an object intruded into a region that the user wanted to be notified about. In the above example, a person walked off the pathway and was detected by two motion event learning map array cells being marked that were not marked on the master learning map.

In an alternate embodiment of this invention, the motion event learning map is compared with the master learning map and individual array cells indicating possible further action being required are identified and then further analyzed using mathematical relationships and the weighted values of other local array cells before a decision to take further action is made.

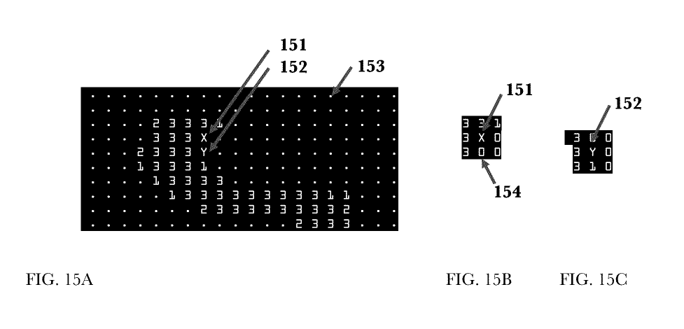

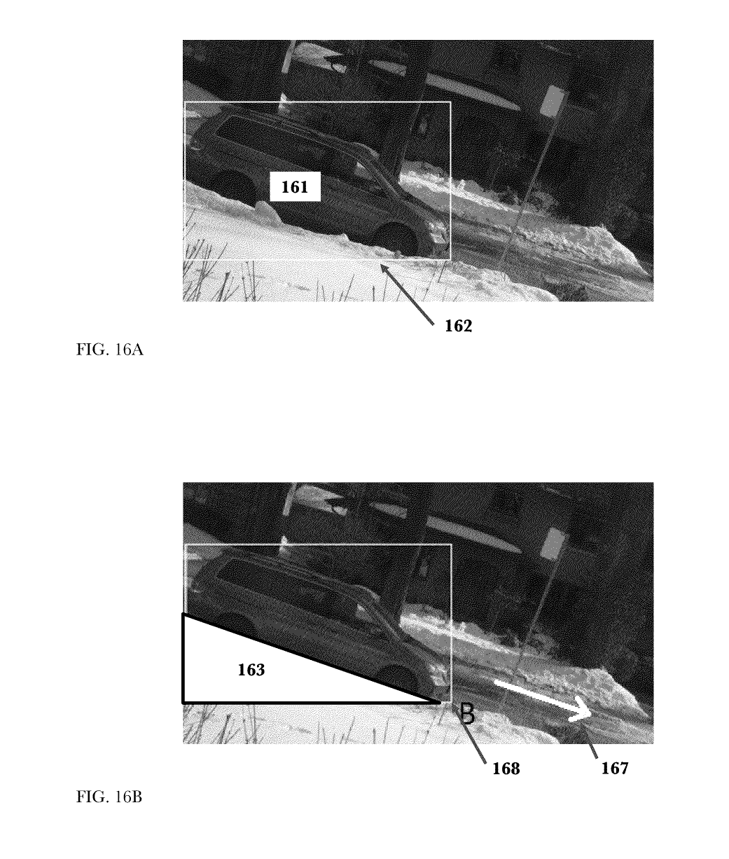

For example, FIG. 15A illustrates part of the master learning map from the example shown in FIG. 12. If a person were to walk up the pathway as described by the motion event learning map shown in FIG. 14A, then as previously described, two cells would have been marked in the motion event learning map that were not marked off in the master learning map. In FIG. 14C these two cell were marked with a ‘0’ 143. In FIG. 15A, these two cells are shown in context of the master learning map shown in FIG. 14B and indicated by an ‘X’ 151 and ‘Y’ 152 shown in FIG. 15A.

FIG. 15B illustrates the cell marked with an ‘X’ 151 in FIG. 15A and the immediate surrounding learning map array cells. In this example, master learning array cells marked with a ‘.’ 153 in FIG. 15A are assigned a value of ‘0’ 154 in FIG. 15B. In this example, the eight neighboring array cells around the array cell ‘X’ 151 under analysis would have values of 3,3,1,3,0,3,0,0, as shown in FIG. 15B. Summing these values gives a total value of 13. This compares to a value of 8 times 3 or 24 that would have been determined if the cell under examination had been in the middle of a region marked with the maximum predetermined cell array value of 3, such as the case if the cell under consideration was in the middle of a marked pathway. Similarly, a value of 8 times 0 or 0 would have been determined if the cell under examination had been in the middle of a region that the user wanted to be notified about. Thus in this example, the total value of weighted cells around any one cell can range from 0 to 24. The array cell ‘X’ 151 in FIG. 15A in the above example had a surrounding neighbor array cell weighting of 13 when divided by 24 and subtracted from one would give an intrusion factor of 46%. In this example, an intrusion factor of 0% would result from a motion being detected in an array cell that was surround by array cells that have been marked with ‘3’, while an intrusion factor of 100% would result from a motion being detected in an array cell that was surround by array cells that have been marked with ‘0’ or an area where the user would want to be notified if motion were to occur.

Similarly, the array cell marked as ‘Y’ 152 in FIG. 15A has surrounding neighbouring cell values of 3,0,0,3,0,3,1,0 as shown in FIG. 15C. Summing these values gives a total value of 10 or an intrusion factor of 58% (1− 10/24). Thus the intrusion that was detected in the array cell marked with a ‘Y’ 152 would be identified as being of more concern that the intrusion that was detected in the array cell marked with an ‘X’ 151.

The above describes one approach to analyzing individual marked array cells in the motion event learning map that correlate with corresponding array cells in the master learning map that were not marked by also considering surrounding master learning map array cells. Based on the result of these individual measurements and their sum in a motion event, a decision to alert the user may be made. This invention also anticipates that other mathematical formulae or relationships and techniques can be implemented in addition to the above described examples. This invention also anticipates that more than just the immediate surrounding array cells could be used in the analysis, for example including the next ring of cells would involve analyzing a group of 5 by 5 array cells or a total of 24 array cells versus 8 in the example given above. This invention also anticipates that when using more than 8 array cells for local analysis, a different weighting could be applied to cells further away from the cell under examination. This invention also anticipates that localized cell analysis can be carried out without using a weighting system and simply using one if a cell was marked on the master learning map and zero if it was not. This invention also anticipates that the result from multiple localized learning map measurements could then be aggregated to determine a measure for the entire motion event.

### M. Assumed Positive Analysis

This invention as described thus far discloses a method by which motion events are detected and recorded, the user observes and characterizes the motion event and the camera then learns how to respond to similar future motion events.

In a preferred alternate embodiment of this invention, the user would view any motion event when an object motion had occurred in a region not previously viewed as previously described, however the user would only be required to explicitly indicate that the motion event was of a nature that the user would want to be notified about in the future. This embodiment is advantageous as the majority of detected motion events are anticipated to be of a nature that the user would not want to be notified about in the future. This embodiment then reduces the amount of interaction with the user and the camera, while providing the same functionality.

For example, the user would be notified the first number of times someone walked up their pathway or a car drove by. The user would view the event, thereby implicitly acknowledging that it was of an approved nature. The camera would then learn to ignore similar motion events and the user would no longer be notified. When a motion event occurs that the user would want to be notified about, such as a person looking in a front window, the user would be notified as is the normal practice. However since it is not desirable, the user would then be required to indicate this on the camera's user interface. Having detected a motion event of interest, the user would indicate this on the camera's user interface and an appropriate action would be taken, such as retaining the video clip from that event.

In an alternate embodiment in this invention, motion event learning maps could be replaced by a mathematical formula or other model representation. Similarly, in another alternate embodiment, master learning maps could be replaced by a mathematical formula or other model representation. An alternate mathematical formula or other model representation of a motion event could then be analyzed against a master learning map or an alternate mathematical formula or other model representation of a reference state for the camera. Similarly, a motion event learning map could be analyzed against an alternate mathematical formula or other model representation of a reference state for the camera.

### N. Diagonal Movement Large Object Problem

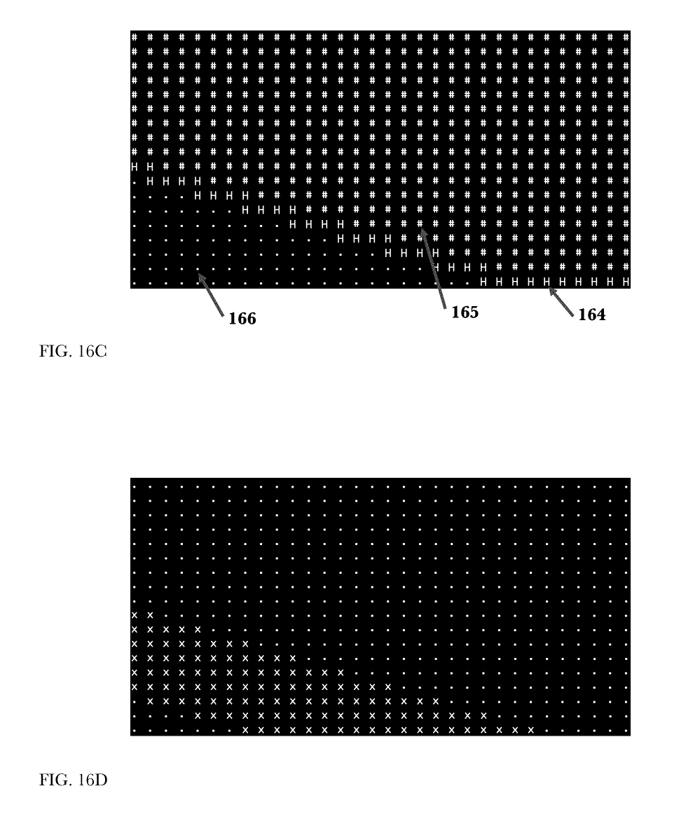

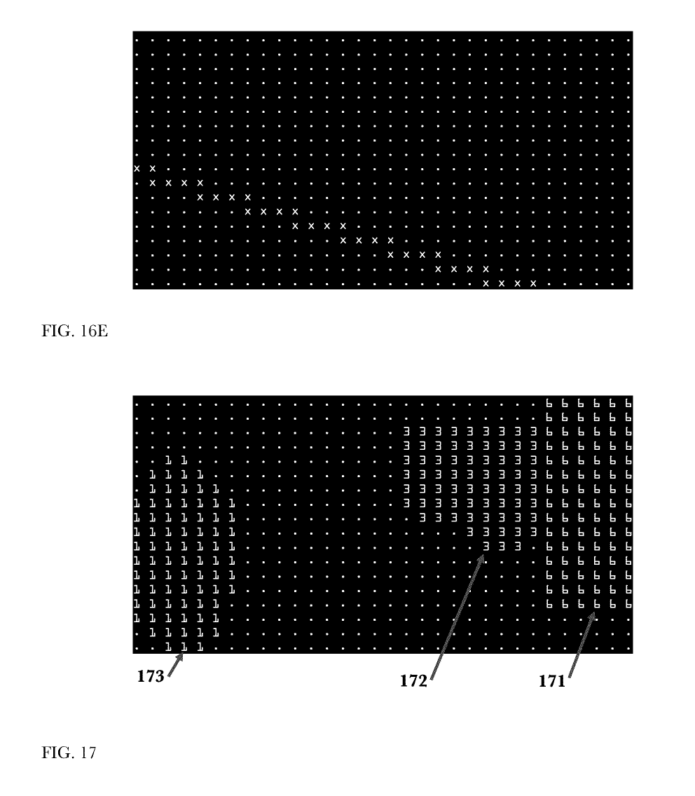

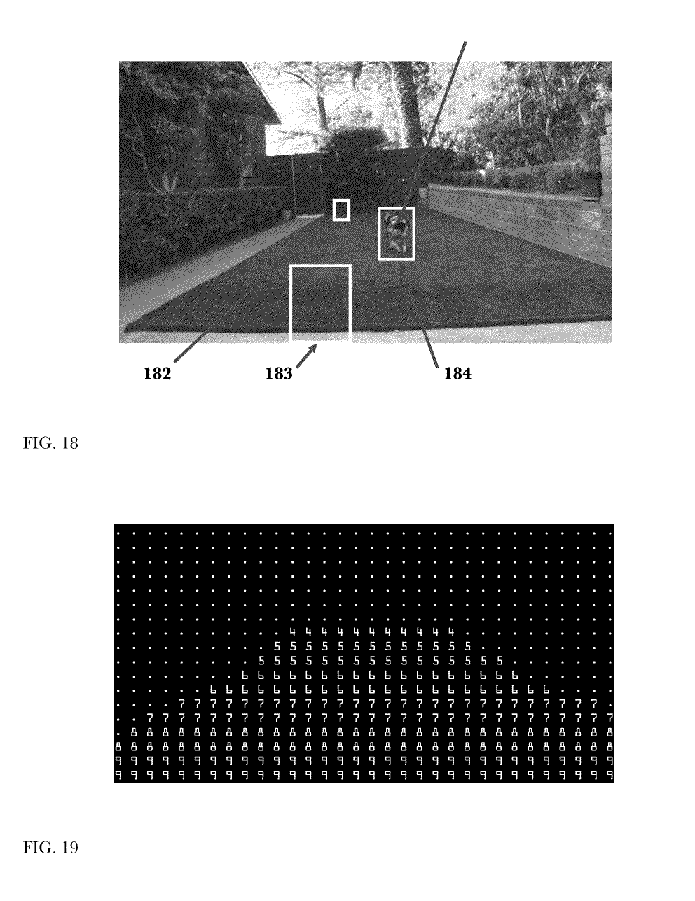

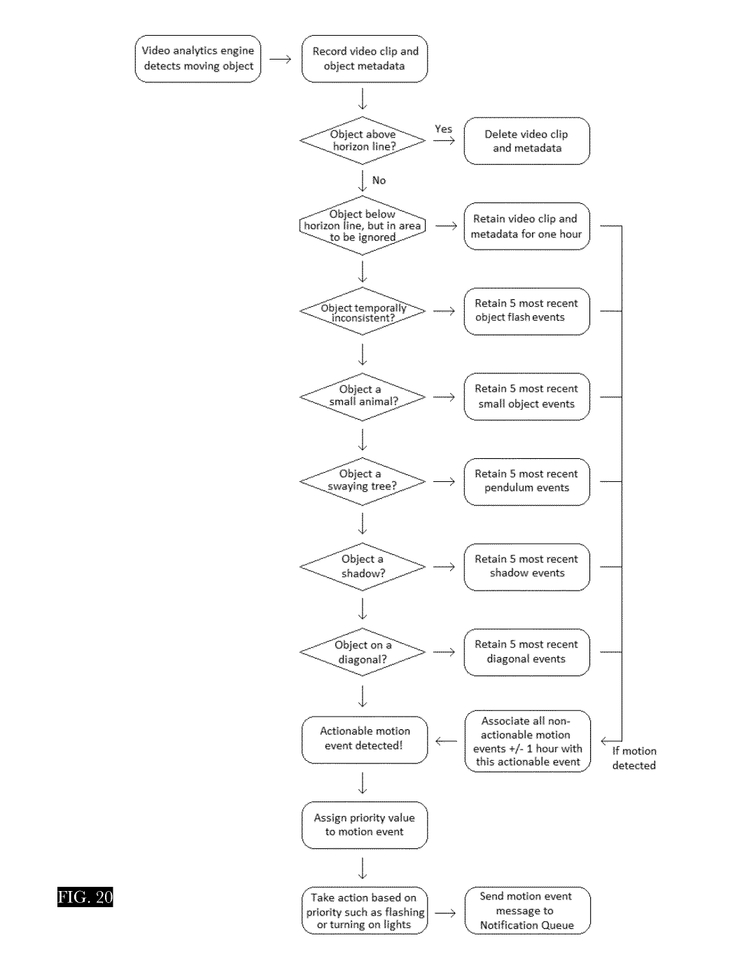

A preferred embodiment of this invention requires that the camera's field of view, video analytics processor's reference frame and the learning map's reference frame be aligned together. It is also desirable that objects within the camera's field of view also be aligned with the camera's viewing axis. However, there are many situations where this is not possible in every area of the field of view. For example, a road turning at an angle to the camera's view would have a portion of the road at angle to the camera. Basic video analytics processors describe an object detected in terms of one or more boxes or outlines in a rectilinear orientation to the video analytics reference frame and hence the camera's field of view. Accordingly, an object moving at an angle in the field of view will not be accurately described. FIG. 16A illustrates an exaggerated example of a car driving by at an angle to the field of view. The camera detects the presence of a moving object 161 as shown by the rectangular white outline 162 drawn around the moving object. However, because the moving object is at an angle to the camera, it would interpret the vehicle being on the lawn as shown in the white triangular area 163 in FIG. 16B under the car and bounded by the white rectangular outline. A person walking by would not be perceived as being on the lawn since they are thin compared to a car, while a long school bus would be interpreted as being half way up the lawn at the back due to its long length.

FIG. 16C illustrates the master learning map that would be properly generated for the example of the camera view shown in FIG. 16A. In this example, people walking by on the road were used to delineate the property line or horizon as indicated by an ‘H’ 164 and all master learning map cells above were marked with an ‘#’ 165 to indicate that region was not of interest or off the user's property. A user would then be alerted if movement was detected as occurring on their front lawn as marked by ‘.’ 166 in the master learning map cells. FIG. 16D illustrates the standard motion event learning map that would be generated by a vehicle passing, as shown in FIGS. 16A and 16B, by using the methodology previously described, which uses the entire bottom edge of the detected object to generate the motion event learning map. In this example, comparing the motion event learning map in FIG. 16D with the master learning map in FIG. 16C would have resulted in the user being incorrectly notified that a motion event had occurred on their property.

In a preferred embodiment of this invention, the width and direction of movement of an object is taken in to account before comparing a motion event learning map with a master learning map. If the apparent width of an object exceeds a predetermined threshold value, for example greater than 10% of the width of the camera's field of view, then a second test to determine the direction of motion would be required. This width threshold value could be predetermined, user adjustable or learned by the camera based on feedback from the user when a motion event contains a large object moving diagonally. In the example shown in FIG. 16A, the vehicle has an apparent width of 57% that of the camera's field of view and would have been flagged for further analysis if the threshold minimum width was set for example to 10%.

Having determined that an object is wide enough to warrant further analysis, the direction of movement needs be determined. The direction of movement of an object would be determined by measuring the distance a corner or centroid of the rectangular frame used to describe the object moves over a succession of frames.

In a preferred embodiment of this invention, if an object is determined to be moving vertically or predominately vertically in the field of view, the entire width of the detected object would be required to properly construct a motion event learning map in a manner as previously described. If an object is determined to be moving horizontally or at an angle greater than 45 degrees to the vertical in the field of view, the defining corner of the moving object should be used to properly construct a motion event learning map. In cases where the object is moving at an angle less than 45 degrees to the vertical, a combination of the full width of the moving object and the defining corner should be utilized. This combination may be determined by taking a weighted average of the two approaches based on the angle of movement to the vertical. This invention anticipates that other mathematical relations or techniques may be utilized to address movement off the vertical direction.

A preferred embodiment of this invention is a method of determining what constitutes the defining corner of a moving object. When an object is detected as moving closer to the camera or moving lower in the field of view, the lower corner of the frame describing the object at the front of the object as determined by its direction of motion is the defining corner. In the example shown in FIG. 16B, the motion of the vehicle is shown by the white arrow 167 and the leading lower corner 168. If an object is detected as moving farther away or higher in the field of view, then the trailing lower corner is the defining corner and should be used to generate the motion event learning map. This invention anticipates other methodologies may be used to construct a motion event learning map in situations where a wide object moves diagonally across the field of view.

FIG. 16E is the motion event learning map constructed by using just the leading front corner 168 of the rectangular frame 162 that describes the vehicle shown in FIGS. 16A and 16B as it moves from the upper left to the lower right in the camera's field of view. When the motion event learning map in FIG. 16E is then compared to the master learning map in FIG. 16C, the camera would then correctly interpret the vehicle driving by on just the road and not as being on the property. Accordingly, the user would not be notified.

On alternate embodiment of this invention entails using a more advanced video analytics processor that describes the presence of a moving object in greater detail using a multisided polygon or similar mathematical description instead of a rectangle. This would result in the shape of the object being more accurately described and eliminate or greatly reduce the problem of tracking long objects moving diagonally. It is also envisioned in this invention that a different correction technique would be required for different object descriptions to correct the diagonal object detection problem.

### O. Shadow Discrimination

One of the most common problems with video based motion detection is the interpretation of a moving shadow as that of a moving object. Lower cost video analytics processors generally only look for changes in colour of pixels to determine whether a moving object is present. A person walking down a sidewalk on a sunny day will often cast a shadow that crosses onto the homeowner's property. A camera would then interpret that shadow as an object moving across the front lawn and alert the user to the presence of a moving object on their property.

Humans recognize shadows as just a localized blocking of direct light that results in lower illumination of the background as the shadow passes over. In one preferred embodiment of this invention, an object can be identified as to whether it is a real object or just a shadow by comparing the texture of the object's location before and after it has moved in to the area being analyzed. A shadow will not change the texture of a background, just its illumination. By comparing the texture of the area where the object was detected with that of the same area in the video frame before and/or after it was detected, the camera can determine whether a real object is present with a different texture to the background or just a change in local illumination with the same texture.

In one preferred embodiment of this invention, image texture measurement and comparison is carried out using a spatial Fourier transform of the moving object's location or area surrounded by the detected object's outline with that of the same region before and/or after the object was detected. In practice, a discrete Fourier transform (DFT) would be carried out on the region of interest defined by the outline of the object generated by the video analytics processor, which identified the moving object. A DFT of that same area would then be taken from a video frame before the object was detected. Comparing the frequency content of the DFT of the image area before and after the object was would indicate whether the object was a shadow (similar high frequency content) or an actual object (different low and high frequency content).

In an alternate embodiment of this invention, techniques other than Fourier transforms or discrete Fourier transforms may be used such as, but not limited to, subtracting pixel intensity values in the region under question before and after an object was detected as a means of determining changes in texture. In another alternate embodiment, a camera with thermal capability may be used to determine a change in temperature and indicate whether an object or shadow is present. In another alternate embodiment, a camera with range find capability such as, but not limited to, radar or ultrasound be used to determine whether an object or shadow is present. In yet another alternate embodiment, more than one camera may be used to determine the position of an object in the third dimension through triangulation. A shadow, lacking thickness or dimensionality in the plane on which it appears would thus not be able to be resolved with this technique and could then assumed to be a shadow and not a real object. This invention anticipates that other techniques and methodologies may be employed to determine whether an object is real or a shadow.

### P. Swaying Tree—Natural Pendulum

On a windy day, trees and branches swaying in the wind can generate continual motion alerts. While a camera would be correct in identifying the motion as that of a real object; it's just not of any interest to the user. Simply ignoring all motion where a tree or branch is swaying would leave the camera effectively blind in that area.

Unlike intruders that move about, trees and branches are anchored at one end (ground or tree trunk) and as a result only sway back and forth Like any pendulum, the period of oscillation is determined by its weight distribution—a function of the density distribution, length and shape of an object. The force of a mild to moderate wind does not change the period of oscillation, just the amount or amplitude of the swaying.

One preferred embodiment of this invention is the means to identify objects such as a tree or branch swaying in the wind with the properties of a natural pendulum. Similar to any motion event, the first time the camera detects a tree or branch swaying in the wind, the user is notified. As part of the learning process, the user would then indicate to the camera that the motion detected is the result of a tree or branch swaying in the wind. In this preferred embodiment, the camera would mark on a separate master learning map or pendulum master learning map regions or array cells where motion was detected and identified as a swaying branch or tree by the user. A measure of the time it takes that tree or branch to sway back and forth would be measured for that location and the pendulum master learning map would be updated with that information. In future, when localized motion is detected in that specific region, the period of motion of that object would be measured and compared with the previously learned periods of motion values for that region of the field of view. A measured amount close to that value could be attributed to that of the tree or branch previously identified. A person walking by in front of the tree or branch would have no period of motion and thus would not be identified as a swaying tree or branch. It should be noted that a pendulum master learning map can refer to a separate learning map, a master learning map with multiple variables values contained in each cell or a different mathematical model or graphical structure that serves the same purpose.

FIG. 17 illustrates the pendulum master learning map generated for the example camera field of view used in FIG. 1. When a tree is first detected to be swaying back and forth, the user would be notified of a motion event. If the user identifies the motion as coming from a tree, which also includes small bushes and tree branches, the camera would then calculate the period of motion (inverse of the frequency of motion or time taken to make one complete pendulum motion or swing) for the object(s) in the area(s) where motion was detected. By definition, an object that can be identified as a natural pendulum cannot move but simply sway back and forth in that area where motion was detected. The time or number of video frames it takes for an object to move and then return to its original position would then be a measure of its period of motion. Having calculated the period of motion for that object in that area, the corresponding cells in the pendulum master learning map would then be updated.

In a preferential embodiment of this invention, the measured period of motions would be multiplied by a factor (in this example 3×) and then rounded to the nearest integer to simplify math required to only integer calculations when subsequently analyzing scenes. In the example in FIG. 1, the tall cedar hedge trees on the right in the image sway back and forth slowly with a long period of motion, which in this example was measured to be 2 seconds. The cells in the pendulum master learning map in FIG. 17 where this motion was detected would then be assigned a value of 6 (2 seconds times 3) in that region 171. The tree near the path has shorter branches and sways back and forth faster with a period of 1 second. Accordingly, corresponding cells in the pendulum master learning map is assigned a value of 3 (1 second times 3) in that region 172. The bush to the far left of the image primarily only has its leaves shake on a windy day with a corresponding very short period of motion of ⅓ of a second. Cells in the pendulum master learning map that correspond to that bush are then assigned a value of 1 (⅓ second times 3) in that region 173. When a moving object is detected and is determined to be swaying, its pendulum motion is measured and compared with previously learned swaying motions for those regions. If the value measured is close to the value learned and assigned in the pendulum master learning map, the camera will not notify the user that an event of interest has occurred. It should be noted that the user is not required to identify which objects are swaying when viewing a motion event video clip, only that trees and branches were observed to be swaying. Any other linear motion, such as a person walking, by would be measured as having an infinite period of motion and thus ignored when calculating periods of motion from swaying objects.

This invention anticipates that a wide variety of mathematical relationships between the measured period of motion and the previously learned period of motion on the pendulum master learning map may be used to compare values and determine if an object is a swaying branch or tree. In this example, a measured period of motion plus or minus 20% would be considered equivalent to the learned and marked period of motion on the pendulum master learning map. To minimize mathematical processing, only integer values are stored in the pendulum master learning map. Accordingly, a mathematical factor may be applied to any measured period of motion measured and consequently saved to the pendulum master learning map. In the example given, the measured period of motion is multiplied by 3 and rounded to the nearest integer value.

This invention also anticipates that the determination of an object not being a swaying tree or branch could be further refined by determining if an object was detected moving linearly into or away from the marked pendulum area—something a tree or branch could not do.

In a preferred embodiment of this invention, each array cell in a pendulum learning map may also have several motion periods associated with it to account for different trees or branches in the same region of field of view.

In another preferred embodiment of this invention, the camera learns different periods of motion for a particular region for different conditions or times of year. For example, a tree would have a different period of motion or swaying frequency in summer versus winter when it has lost its leaves. Similarly, the pendulum master learning map may have different values for different illuminations. One example being the camera may detect one portion of a tree illuminated by sunlight but a different portion when backlit by a street light. Similarly, the pendulum master learning map may have different values for different times of day when illuminated by sunlight from a different direction or on overcast days where there is no direct sunlight. In another preferred embodiment, the camera uses time of year, time of day and overall camera illumination or scene brightness to determine which of several pendulum values to use based on similar conditions present when the reference period of motion was determined for that region.

This invention also envisions the user being able to update the period of motion values for the pendulum master learning map in localized areas as a tree or branch grows without having to reset the entire pendulum master learning map. It is also envisioned that the user can manually update the pendulum master learning map directly or through a user interface.

In an alternate embodiment of this invention, a binary value could be used to identify the presence of an object with a swaying motion of any period of motion value. The camera would learn to ignore any swaying motion of any period at learned regions of the field of view. Any moving object would be distinguished as having no period of motion.

In another alternate embodiment of this invention, no pendulum master learning map would be required. Instead, all pendulum motions anywhere in the field of view would be assumed to not be of interest to the user. When a motion event occurs, part of the screening process would entail determining if the motion of the object was pendulum like by measuring its period of motion or lack thereof.

### Q. Small Objects

Most users implement security systems to monitor for the presence of unauthorized humans approaching their home from outside. However, it is quite common to have considerable animal activity, whether from the family pet and mice indoors or pets, squirrels and raccoons outdoors. In each case, the size of the object can be used to determine whether to notify the user or not.

Each camera set-up is unique with the apparent size of an object dependent on the mounting height of the camera, lens and sensor used and how far the object being detected is away from the camera. Similar to instructing the camera to learn to ignore a tree blowing in the wind, the camera can also be instructed to ignore small animals or other small objects moving about.

In a preferred embodiment of this invention, when a motion event is triggered and the user determines that it was from a small animal or object and to be ignored, the camera can be trained to ignore objects of that apparent size or smaller at that point in the field of view. FIG. 18 illustrates how the same object, in this example a dog 181, will have different apparent sizes depending where it is in the backyard 182, 183, 184.

In a preferred embodiment of this invention, the distance from the object detected to the camera is a function of the object's location in the field of view as measured from the distance at the bottom center of the image frame to the center of the bottom edge of the object detected. When the camera detects a motion event and the user identifies it as resulting from a small animal or object after viewing the associated video clip, the camera can then determines the maximum apparent size of moving objects to ignore at different points from the bottom center of the image. Similar to other learning maps, this preferred embodiment of this invention incorporates a small object master learning map that is updated based on a response to viewing a motion event video clip, identifying it as containing a small object motion and then updating the small object master learning map using data from the motion event learning map. It should be noted that a small object master learning map may refer to a separate learning map, a master learning map with multiple variables values contained in each cell or a different mathematical formula or graphical structure that serves the same purpose.

FIG. 19 illustrates the small object master learning map generated after the user had received a motion event alert caused by the family dog walking about the entire backyard as shown in the example in FIG. 18. When the user observes the video clip associated with the motion event they would observe the dog walking around in the backyard. Due to the camera's perspective, the dog would have a different apparent size depending on its position in the backyard at that moment. This is illustrated by the different white rectangular object outlines 182, 183, 184 shown in the example in FIG. 18. The size of the object appears to be smaller as the object moves farther away from the camera, which is in part a function of the distance of the bottom edge of the object to the bottom center of the camera's field of view.

In a preferred embodiment of this invention, when a motion event has been identified as that resulting from the movement of a small object or animal by the user, the apparent size of the object at different distances from the bottom of the field of view is determined from the motion event learning map and object metadata and recorded in the small object master learning map. More specifically, the measured apparent size of the object would be noted in the small object master learning map array cells that coincide or overlap with the bottom edge of the detected object. FIG. 19 illustrates the result of multiple motion events where the dog in FIG. 18 is observed to walk all around the backyard. Similar to other learning map applications, in this preferred embodiment, a mathematical factor is applied to all measurements and then rounded such that the small object learning map contains only integer values that can easily be calculated and analyzed using integer math. In the example shown in FIG. 19, the values in the cells of the small object master learning map are a multiple of the number of pixels of the height of the object. When a motion event is detected, the size of the object at different locations where it was detected is then be compared to the maximum object size of that location that had been learned on the small object master learning map. If the size of an object detected was greater than the maximum small object at that particular location from the bottom center of the field of view in the small object learning map, further action would then be required.

This invention anticipates that when a larger animal is detected than previously accounted for and identified as a small object or animal, the small object master learning map is updated for the larger values wherever measured.

This invention also anticipates that an entire small object learning map may be generated from one or a small number of motion events. The reference object, in this example being a dog, need not move everywhere in the field of view. In a preferred embodiment of this invention, a small number of samples close up or low in the field of view and farther back or higher in the field of view may be used to calculate the maximum size values for all the respective small object learning map cells.

In an alternate embodiment of this invention, a sample set of measurements may be used to interpolate and extrapolate the appropriate value for all positions in the small object learning map. For example, apparent size measurements of the dog in the example at the same distances from the camera or positions on the same learning map row would have the same apparent size. Thus one embodiment would have one apparent size measurement being used for the value of all cells in a small object learning map row. In an alternate embodiment, the apparent size of an object at different locations on a learning map could be calculated by taking two measurements of the same object's apparent size at two different locations and interpolating values using a linear or other arithmetic function between the two measured points. Similarly, in yet another alternate embodiment, the apparent size of an object could be extrapolated from two measured locations using a linear or other arithmetic function. Combining the above three embodiments, this invention anticipates that an entire small object learning map could be determined by taking as few as two apparent size measurements of a small object. The apparent size between the two measured points would be interpolated; the apparent size on other rows extending to the top and bottom of the field of view could then be calculated through extrapolation. Finally all cells on a given small object learning map row would be given the same calculated value.

In an alternate embodiment of this invention, that the size of an object may be determined by measuring its apparent height as shown in the example in FIG. 19, its apparent width, both measurements individually or its apparent area (width times height). A 3D camera may also extend this concept to include its apparent volume (width times height times length).

In an alternate embodiment of this invention, the small object learning map may be replaced by a mathematical formula calculated from motion events where multiple apparent sizes of the object are calculated at different locations from the bottom center of the field of view. The resulting formula may be a mathematical function fitted from the measured points and would be expressed as a maximum size allowed as a function of the distance from the bottom center of the field of view. In subsequent motion events, the size of an object detected would be compared to the maximum small object size allowed by inputting the distance from the bottom of the field of view that the object was detected. It should be noted that this equation should generate the same results it were applied to calculating apparent size values in the small object master learning map.

In most camera applications, the perspective of the camera is such that the distance from the bottom edge of the field of view may be used in calculating apparent size and not necessarily the distance from the bottom center of the camera's view. An alternate embodiment of this invention involves applying a correction factor based on how far from the center axis of the field of view the object was detected. This factor could either be calculated by measuring the apparent size differences of the object as it moves left to right or a predetermined factor or mathematical relationship based on the lens and sensor used.

The area being monitored need not originate where the camera is located. An alternate embodiment of this invention is to monitor a region distant from the camera's location. The relationship with apparent size and location in the camera's field of view can similarly be determined by sampling the apparent size of the same object at different locations in the region of interest.

This invention also anticipates that values for the small object master learning map cells may also be manually entered by the user or through a suitable user interface.

This invention also anticipates that values for the small object master learning map cells need not be integers and may also be other value representations and involve the use of other mathematical operations.

### R. Object Flashes

For a number of different reasons, video analytics processors will often identify the presence of an object for a small number of video frames, often less than three, when no object is actually present. Often a sudden change in overall lighting, a momentary reflection of light or while tracking another object, the video analytics processor will trigger an erroneous identification of one or more multiple objects. In almost all cases, the object(s) will appear for just a couple of frames and then disappear. If an object appears for 3 frames using a typical monitoring camera operating at 15 frames a second, then the object would only appear for 3/15 or 0.2 seconds. Since appearing and then very quickly disappearing is not a characteristic of a real object, these occurrences can safely be ignored when an object momentarily appears and then disappears or is temporally inconsistent.

In one preferred embodiment of this invention, a filtering mechanism is used whenever a moving object is detected for a small number of frames—for example three or less, and can be ignored as unlikely to be the result of the motion of a real object.

### S. Motion Event Prioritizing

An important preferred embodiment of this invention is the concept that a motion event can be assigned a priority with which it should be dealt with in addition to the time the event occurred. For example, the detection of a moving object within a house should be given greater priority over an object motion detected outside of a house. Similarly, the detection of someone moving near a window or door should be given greater priority over the detection of someone standing at the end of a driveway.

The most basic prioritization of motion events are those deemed non-actionable versus actionable. As the label implies, non-actionable motion events require no follow on action to be taken and are thus assigned the lowest priority.

A preferential embodiment of this invention is that a motion event is assigned a priority based on a number of factors including, but not limited to, the position in a camera's field of view that an object was detected moving in. Another preferred embodiment uses the lowest position of any object(s) observed during a motion event, as measured by the bottom edge of its outline description, to assign the priority of the entire motion event. Motion events with learning map array cells marked lower in the field of view would be given higher priority over a motion event with array cells marked higher up or farther away in the field of view.

In alternate embodiments of this invention, the measure of how close an object is in the camera and thus of higher priority may be determined by its vertical distance with respect to the bottom of the field of view of the camera, its horizontal distance with respect to the center axis of the field of view of the camera, or a combination of both including a diagonal measurement from the bottom center of the field of view of the camera. In all cases, the distance from the object is preferentially measured from the object's bottom center.

An additional embodiment of this invention has other factors used to assign priority including, but not limited to: the percentage of time an object was detected as moving within the motion event, percentage of time the motion event occurred in an area the user wanted to be alerted about versus the time it spent in an area to be ignored; the relative apparent size of object(s) detected; the number of other actionable and non-actionable motion events that occurred around the time of the motion event under consideration; the time of day or total illumination at the time of the motion event; where multiple cameras are deployed different cameras may be given different priority or inside facing cameras may be given priority over outward facing cameras; as well a combination of some or all of the above. Age or time that the motion event occurred would also be a key factor with all other factors being equal; a more recent motion event would be given priority over an older event. This invention also anticipates that users may establish their own individual criteria and order of prioritization and that different users may have the camera respond differently to the same prioritization factors.

### T. Motion Event Handling

A series of moving object identification routines have been described that enable the camera to characterize different motion events and respond accordingly. A preferred embodiment of this invention is that the analysis of new motion events be carried out in a systematic way to minimize processing required. Analysis or steps with the least amount of processing required or steps most likely to result in an identification of a motion event should be carried out first. When a motion event of no interest is identified, then no further analysis or steps is required.

In a preferred, but not restrictive embodiment of this invention, the following steps, as illustrated in FIG. 20, is an example of one order of analysis that may be carried out when a camera has detected the presence of an object moving in the field of view and a motion event triggered:
1) Upon detecting a moving object in the camera's field of view, a motion event is triggered or declared. A video clip, associated metadata generated by a video analytics processor and other related information is recorded. A motion event learning map or similar mathematical model is then generated using this information.
2) If a horizon or property line has been previously learned and recorded on the master or property line learning map, a horizon line test is first performed. If the detected moving object is found to be above that line or off the user's property, the motion event information including video clip, metadata and other data, may be optionally deleted after a period of time such as an hour and no further action taken. A count of the number of events identified above the horizon line (if present in the master learning map) is also retained for additional analysis if required.
3) If the detected moving object is determined to be below the horizon line or no horizon line was created, but within an area marked to be ignored, no further steps are taken and the video clip and metadata are retained for a period of time. In this example, the information is saved for one hour. A different time period or number of events could also be used as the criteria for temporary retention of this information. A count of the number of events identified below the horizon line (if present in the master or property line learning map) is also retained for additional analysis if required.
4) If the object is determined to be temporarily inconsistent or found to have appeared for only a couple of video frames, it is assumed that the object was not real but a temporary artifact. No further steps are taken and the video clip and metadata are retained for a nominal period. In this example, the five most recent temporarily inconsistent or object flash motion events are saved for inspection if it becomes a consistent problem. A different number of events or periods of time may also be used as the criteria for retaining this information. A count of the number of events identified as object flashes or temporarily inconsistent is also retained and the user notified if this problem exceeds a normal level of occurrences.
5) The size of object(s) detected in an area the user wishes to be alerted about is then compared with the small object master learning map or similar mathematical or graphical model. If the object is found to be smaller than the maximum small object size learned by the camera in that region, no further steps are taken. In this example, the five most recent small object motion events are saved for future inspection. A different number of events or periods of time could also be used as the criteria for retaining this information. A count of the number of events identified as small objects is also retained for additional analysis if required.
6) The location of the detected object is then compared with regions marked on the pendulum learning map. If a detected object appears in a region of the field of view that has been marked as a pendulum, the period of motion of the object in the motion event learning map is then compared with marked values in that region of the pendulum master learning map. Any object motions confirmed as from a natural pendulum such as a tree or branch would then be ignored and no further steps taken. If any additional motion is detected, but not marked as a natural pendulum, further analysis steps would be taken. In this example, the five most recent natural pendulum motion events are saved for future inspection. A different number of events or periods of time could also be used as the criteria for retaining this information. In an alternate embodiment, all motion events that reach this stage would be analyzed to determine if due to a natural pendulum, regardless of location or prior motion detections. A count of the number of events identified as natural pendulums is also retained for additional analysis if required.
7) Objects detected are then analyzed to determine if they have image properties consistent with that resulting from the movement of a shadow. If the object is determined to be a shadow, no further steps would be taken. In this example, the five most recent shadow motion events are saved for future inspection. A different number of events or periods of time could also be used as the criteria for retaining this information. A count of the number of events identified as shadows is also retained for additional analysis if required.
8) Objects are then analyzed to see if there is a problem with accurately characterizing long objects due to the diagonal capture artifact. If the object is determined to be within an area of no interest after accounting for its movement on a diagonal, no further steps would be taken. In this example, the five most recent diagonal artifact motion events are saved for future inspection. A different number of events or periods of time could also be used as the criteria for retaining this information. A count of the number of events identified as diagonal artifacts is also retained for additional analysis if required.
9) It is anticipated in this invention that other steps may be taken at this point to further identify and rule out motion events that the user may not want to be notified about.
10) If a motion event passes through all of these steps or analysis and has not been identified as an event the user doesn't want to be notified about, it is deemed to be an actionable motion event. In a preferred embodiment of this invention, all actionable and non-actionable motion events prior to or after the time of the actionable motion event are flagged and associated with the actionable motion event. The associated non-actionable events are no longer automatically deleted, but are managed together with the actionable event. This allows the user to see all motion events detected by the camera before and after the main actionable event to provide a complete view of what has occurred. This invention anticipates that multiple cameras may also be used. Thus a non-actionable motion event captured by other cameras around the time of the actionable event would also be associated for later reviewing and handling together with the actionable motion event. Similar to non-actionable motion events, actionable motion events would also be associated with actionable motion events within the determined time period. In this example, all non-actionable and actionable motion events occurring within an hour before or after would be associated with the actionable motion event of interest. A different time period or other criteria may also be used as well as one set by the user.
11) Having been identified as an actionable, the motion event would be analyzed and a priority factor assigned to it.
12) Based on the priority value assigned, some actions may be taken immediately. In this example, a high priority motion event would trigger flashing lights on the camera to alert potential intruders that they are being recorded. This invention anticipates other actions could be taken based on the priority assigned including notifying a third party, triggering an action in a home automation or security system as well as commencing a remote backup of recorded video to minimize the risk of locally stored video being stolen or damaged.
13) Finally, a message is sent to the notification queue that an actionable motion event has occurred.

This invention anticipates that additional or fewer steps or a different order of the above steps may be advantageous.

### U. Notification Queue

As illustrated in the example shown in FIG. 20, the camera's video analytics processor continually analyzes the video images for any signs of motion and if detected, generates a motion event. The camera then analyzes the motion event's associated metadata against a set of criteria that has been previously learned by the camera, such as that contained in the master learning map. If a motion event is deemed actionable, the video and metadata corresponding to that motion event are then recorded and a motion event message is sent to the notification queue.

A preferred embodiment of this invention is the use of a notification queue to manage motion event messages, which are then used to alert the user that an actionable motion event has occurred.

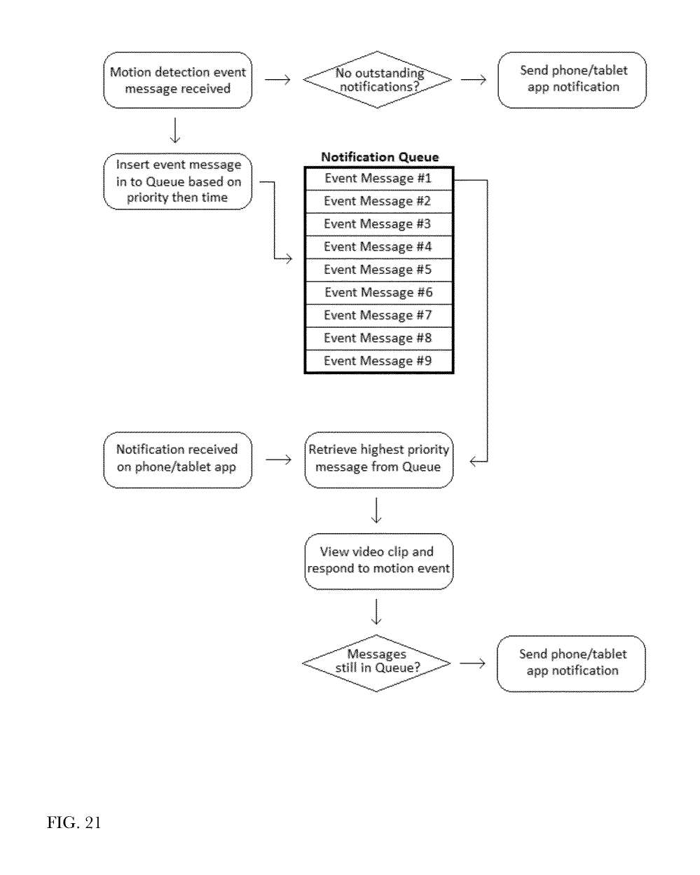

In a preferred, but not restrictive embodiment of this invention, the methodology used with a notification queue is illustrated in FIG. 21. When a motion event message is received by the notification queue, the first step is to determine if any other motion event messages are outstanding. If there are no current outstanding motion event messages, the user is sent a notification through any method of their choosing including but not limited to a siren, flashing light, email, text message, automated or manual phone call, messaging platform, operating system notification, app notification, social media alert or an indicator on the user app or camera.

The motion event message is also sent to the notification queue. As long as there is an outstanding notification sent to the user, any subsequent actionable motion event messages received are directly placed in the notification queue in the order determined by the assigned priority value or ranking and the time when the event message was generated. If a higher priority event is received, it is pushed ahead of lower priority events in the queue to be acted upon before other lower priority events, even though they would have been in the queue longer. This approach ensures that motion event messages are sorted in the notification queue by their previously assigned priority ranking and that the user always deals with the most important issue first. Motion event messages of the same priority are the sorted by the time they occurred in the notification queue. Once a notification is sent to the user, no additional notifications are sent until the current notification has been viewed and dealt with. This is advantageous as it prevents the user from being overwhelmed with multiple notifications being generated from each actionable motion event.

In another embodiment of this invention, additional notifications may be sent to the user depending on the time since the last notification was sent or the priority ranking of event messages in the notification queue. For example, the camera may be configured to send a follow on email if the user doesn't respond within a period of time, such as ten minutes, with additional messages every twenty minutes, for example, following that. In another example, when only low priority messages are in the notification queue, an email notification is sent to the user. When a medium priority message is in the notification queue, the alert level to the user may be raised by sending a text message, while a high priority message alert could involve an email, text and automated phone call. Finally, a very high priority motion event message in the notification queue could result in a third party being contacted or other alert mechanism.

In another embodiment of this invention, the timing and priority of multiple motion events received may also be used as a criteria to escalate the notification to the user. For example, twelve low priority messages generated within a two minute period would be pushed higher up the notification queue than a single medium priority motion event occurring previously. Notification to the user could also be escalated if multiple actionable motion alerts were generated in a short period of time.

### V. User Response Options

Having received a notification of a motion event from the camera, the user would then access the camera through a mobile device app, program, web page or similar user interface. When a user is alerted that an actionable motion event has occurred, a notification alert is also sent to the camera's user interface. In an embodiment of this invention, when the camera's user interface is then accessed, the top most motion event message is retrieved from the notification queue as shown in the example in FIG. 21. Note that the motion event message being retrieved is not necessarily the motion event that prompted the original triggering of the notification alert to the user. One example would be an intruder hopping a backyard fence triggering the first actionable, but low priority motion event. A subsequent motion event of the intruder looking in a window would be given a higher priority, since the person is now closer to the house. If the intruder then broke in to the house, an internal viewing camera capturing the person would generate a motion event of the highest priority. Thus the first motion event viewed by the user would be that of the person inside the home, despite the original alert being a result of the person earlier hopping the fence.

In an embodiment of this invention, after the user interface retrieves the current highest priority motion event message from the notification queue, the user would then view the associated motion event video clip and respond through the user interface in a number of ways based on what was viewed in the motion event video clip. In an embodiment of this invention, the user feedback based on viewing a motion event is the mechanism by which the camera learns what to alert the user about.

In a preferred embodiment of this invention, the user identifies or describes the nature of the observed motion and this information is then used to compare and identify future motion events.

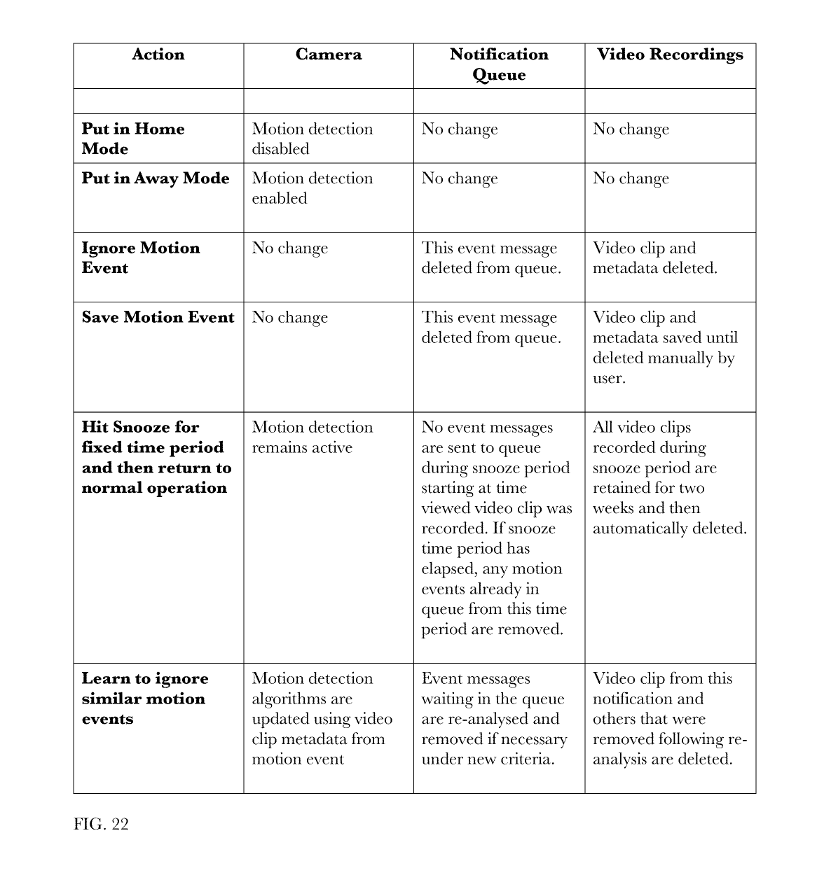

In a preferred, but not restrictive embodiment of this invention, user responses would include, but not be limited to the list below and as illustrated in FIG. 22:

1) Put In Home Mode—The user wants the camera to stop tracking motion events until further notice.
2) Put In Away Mode—The camera is put in active mode, which enables motion detection.
3) Ignore Motion Event—The motion event was due to an event that the user doesn't care about, but would still want to be notified if a similar motion event were to happen again. The motion event would be deleted along with its associated video and metadata. One example being a kid running on to the front lawn to retrieve a ball.
4) Save Motion Event—The video clip and associated metadata from the motion event are saved for future viewing; however the camera's motion detection algorithms are not updated.
5) Snooze Mode—A motion event is observed and was due to an event the user doesn't care about, but would want to be notified if a similar event were to happen again. Similar to the snooze button on an alarm clock, the camera could be set to snooze or to ignore any motion events for a specified period of time. One example being a gardener setting off a motion alert resulting in the user receiving a notification alert. Having observed the video clip related to that motion event and concluding that it was someone that was supposed to be there, the camera could be set to snooze for one hour or any other appropriate length of time. Any motion event that occurred from the time that motion event occurred onwards for one hour, or whatever time period chosen, would then be removed from the notification queue preventing multiple alerts from the same activity. It should be noted that it wouldn't matter if the user responded to the motion event at the time that it happened or several days later. By putting the camera in snooze mode, you are preventing subsequent notification alerts from being sent during that time period and not stopping the camera from generating motion alerts. If the user responds with a snooze command for a motion event that occurred in the past, the camera would remove all messages generated from the time of the motion event to the end of the snooze period, return to normal mode and forward the next message in the notification queue. Note that when a motion event is viewed does not impact how it and subsequent motion events are handled. The camera could also be set to retain any motion events with associated videos that were ignored under a snooze command for a period of time before being automatically erased. One example being the user discovering the gardener had caused some damage while working in the yard. The user would still have access to the video for a period of time as evidence of who caused the damage.
6) Learn—the user observes a motion event and doesn't want to be alerted about similar motion events going forward. Having selected Learn, the user would then be presented with a number of choices as detailed in the example below. In each case, the camera would take the motion event with associated metadata including motion event learning map and update the corresponding master learning maps and other reference data information based on the identification of the motion event by the user. In a preferred embodiment of this invention, the user would have a number of options to update the camera's learning algorithms such as, but not restricted to, the following examples:
   Outside of Property Line—The observed motion event did not occur on the user's property. The motion event learning map would then be used to update the horizon or property line in the master or property line learning map.
   Pathway—The observed motion event occurred on the user's property, but in an area such as a walkway where the user wants to only be selectively notified based on other criteria such as time of day or whether they are home or not. The motion event learning map from this motion event would then be used to update the master learning map. This invention anticipates that more than one pathway description may be utilized.
   Object Flash—An object was observed in the motion event for only a few frames and thus its detection would be temporally inconsistent with a real object. While the camera would reject very short object flashes as part of its base configuration, the camera could also learn to ignore longer object flashes under specific conditions. The master learning map may also be marked to ignore longer object flashes in certain regions of the field of view at, for example, certain times of the day to minimize this effect.
   Small Animal—A small animal moving about was observed to be the cause of a motion event. The apparent size of the animal at various positions in the field of view would then be used to update the maximum object allowed in the small object learning map.
   Swaying Tree—Tree(s) or branches blowing in the wind were observed to be the cause of a motion event. The period of motion of the object(s) would then be calculated for various areas in the camera's field of view where it had occurred and then the corresponding cells in the pendulum learning map would be updated.
   Shadow—A moving shadow and not a real object was observed to be the cause of a motion event. The shadow discrimination analysis routine is then be updated based on this motion event to improve its efficiency.
   Long Object Moving Diagonally—The motion event was observed to be triggered by the diagonal movement of a long object off the user's property. The moving diagonal object discrimination analysis routine is then updated based on this motion event to improve its efficiency.
   User Defined—This invention also anticipates that other options could be provided including user defined identifications where the user would be able to create new criteria based on their own specific needs.
   Advanced Object Detection—This invention also anticipates that more advanced video analytics processors may have the capability to carry out more advanced object recognition. This invention anticipates that this more advanced capability may also be used with the camera's video confirmation feedback to improve its response to new motion events. Examples of advanced moving object recognition may include, but not be restricted to identifying objects with faces, as bipedal humans, four legged animals or vehicles with rotating wheels.

In a preferred embodiment of this invention, once an actionable motion event is observed and the user responds, the camera would then go back and re-evaluate all motion events currently waiting in the notification queue using the newly revised motion detection characterizations or learning map values. Motion events that were previously determined to be actionable, may now be determined to be non-actionable and removed and thus not require the user to review it. This would help minimize the user needing to respond to similar motion events that have already occurred and would have been ignored following the latest update of the camera's motion event analysis routine.

### W. Camera Modes

In a preferred embodiment of this invention, the camera is operated in different modes, which control its operational behavior. This embodiment anticipates that different users can set the camera to be operating in different modes at the same time. Examples of camera modes previously disclosed in this invention include Home Mode, Away Mode and Snooze Mode. Modes of the camera may also control a number of other factors for example and not limited to:
Motion detection enable, disabled or modified,
User notification alerts enabled, disable or modified,
User notification alert criteria or method of notification,
Settings or versions of the master/property line/small object/pendulum learning maps or other reference database or variables being used for analysis,
Camera settings such day/night filter, visual or audible alerts,
Use of remote back up storage.

This embodiment anticipates that the camera may be put in certain modes, such as Home, Away or Snooze, manually by the user through the user interface; externally through another controlling system such as, but not limited to, a home automation or security system, other cameras; as well as automatically or systematically through other externally controlled variables such as, but not limited to the time of day, date, season, scene illumination, outside temperature, weather report or snow cover.

### X. Alternate Uses—Speed Camera

Cameras cannot directly measure linear motion across a field of view, but rather can only measure angular motion in terms of pixels crossed per second. An embodiment of this invention is that the camera described can characterize properties of an object's motion and apply this knowledge to future detected moving objects.

One embodiment of this invention is the use this camera as a speed detector in speed camera mode. In this mode, the user would record a motion event of an object with a known speed. For example, a car could be driven down the street in front of a house at a constant speed. When viewing the motion event, the user could then select the speed camera option and enter what they know the speed of that car to be. The camera would then calibrate the speed of that observed object at that distance from the camera, which is a function of how far from the bottom of the field of view the vehicle or object was observed to be moving. For situations where objects are observed to be moving closer to or farther from the camera, additional test runs at different distances from the bottom of the field of view or distances from the camera would be required to fully calibrate the camera. The speed of an object travelling between two distances from the camera could be interpolated from the two calibration points similar to calculating apparent size of an object as previously disclosed. Note that speed calibration does not depend on what direction the vehicle is travelling only that its distance from the camera be consistent with any calibration carried out.

In an alternate embodiment of this invention, the camera can be calibrated for speed measurements by manually entering the width of a known object at a position in the camera's field of view. Speed or velocity of an object at that position can then be determined. Multiple calibration points can also be used to interpolate and extrapolate the speed or velocity of an object at other locations in the field of view.

In an alternate embodiment of this invention, the camera could also be used to determine speed, velocity, rotation and acceleration of a moving object by taking in to account measured velocity changes at different locations in the field of view.

In an alternate embodiment of this invention, the camera could also be used to detect the presence of a stationary object by detecting its movement into the field of view, but not detecting an object moving away from that same location in the field of view.

In one application, the camera could be set to collect speed statistics on any object driving by over a minimum speed of, for example, 15 km/h to eliminate detections of pedestrians walking by and cars parking, while also alerting the user and recording video of any car exceeding a maximum set speed. Since the camera is not an officially calibrated police instrument, its results may not secure a speeding conviction in court. However, it would be a useful tool to demonstrate that a problem exists requiring more official surveillance. The camera could also be set to alert the user whenever automobile or pedestrian traffic moved in an undesired direction, such as a car driving down the wrong way on a one way street or someone entering a facility through an exit door. In addition to monitoring automotive or pedestrian traffic flow, the camera could also be used to monitor boat speeds in a bay or a narrow channel where there are wake/speed restriction. In this example a control boat moving at a known speed would first have to be recorded to calibrate the system.

### Y. Alternate Use—Patient Monitoring

Remote video monitoring of patients in elderly care facilities or at home is often deemed undesirable for privacy reasons. By tracking objects and not people, privacy can be maintained and reduce the need to have caregivers constantly monitoring video feeds. One embodiment of this invention is to use the camera as a patient monitoring solution that can be set to alert the user or other approved party if a learned motion event does or does not occur. An alternate embodiment would be to monitor any moving object for motion that should or should not be occurring.

One example of this embodiment is the monitoring of a patient in bed. The camera would detect motion events such as the person rolling over in bed or getting out of bed. By identifying the person rolling over in bed as a bed movement and identifying the person getting out of bed as a leaving/returning bed movement, a patient's movement can be monitored without visually watching them. A user could be alerted if the patient didn't roll over after a period of time, didn't get out of bed after a period of time or get out of bed by a certain time of day. Using multiple cameras, the patient could be tracked and the user alerted if the patient got out of bed but wasn't detected walking through their bedroom door or returning to bed after a period of time, suggesting they may have fallen. Similarly, a kitchen can be monitored to ensure that the patient is having regular meals. A care provider, for example, could receive a notification alert if a motion event wasn't detected after a certain period of time. With prior approval from the patient and/or guardian, live and previously recorded video of the person could optionally be made available to ascertain if in fact there is a problem requiring immediate attention when an alert is triggered from certain motion events being detected or not being detected depending on set criteria.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention claimed is:

1. A method of security monitoring with a video camera apparatus where a user observes a video of the detection of object(s) of interest, provides feedback to the camera based on said observations and as a result, improves the accuracy or reliability of future detections of object(s) of interest.

2. The method of claim 1, further comprising the following steps of:
detecting the presence or lack thereof of an object(s) of interest;
generating information about said object(s);
comparing said information about said object(s) with reference information;
characterizing said object(s) based on said comparisons;
determining whether to notify user or not based on said characterization;
a user observing said object(s) and further characterizing said object(s), if required;
updating said reference information with information about said object(s), if required;
enacting a course of action based on characterization of said object(s), if required.

3. The method of claim 1 or 2, wherein the characterisation of said object(s) being determined in part by its motion over a defined period of time referred to as a motion event.

4. The method of claim 1, 2 or 3, wherein said information is described by a mathematical representation referred to as said learning map.

5. The method of claim 1, 2 or 3, wherein said further characterization of the reference information improves the accuracy of determining whether to notify the user or not.

6. A mathematical representation or model of a camera's field of view suitable for describing the presence and motion of object(s) over a period of time.

7. A mathematical representation or model recited in claim 6, wherein multiple instances of said models describing multiple periods of time may be summarized to describe the presence and motion of object(s) for all instances.

8. A mathematical representation or model recited in claim 6 or 7, wherein said mathematical representation or model is referred to as a learning map, comprising:
a plurality of cells, each which may contain information;
the cells arranged in an array of rows and columns;
the array being spatially aligned with the camera's video image field of view;
the array being spatially aligned with the camera's video image processor's frame of reference;
a one-to-one spatial mapping between said cells and pixels in said video image; and
location and size of said object(s) described by video image processor described by information in spatially corresponding said cells.

9. A learning map as recited in claim 8, wherein said object(s) presence and motion during said motion event is described by information.

10. A learning map as recited in claim 8 or 9, wherein only the lower edge of said object(s)'s size description is used to describe said object(s)'s presence in corresponding said cells.

11. A learning map as recited in claim 10, wherein only the defining lower corner of an object(s)'s description is used to record said object(s)'s presence in corresponding said cells when said object is moving at an angle near the learning map's horizontal axis.

12. A learning map as recited in claim 8 or 9, wherein a combination of features in claims 10 and 11 are used depending on angle of motion to the learning map's axis.

13. A learning map as recited the above claims, wherein it is also used as a reference map for describing information from multiple motion events.

14. A learning map as recited in claim 13, wherein said cells are assigned specific weightings based on the object(s)'s motion.

15. A learning map as recited in claim 13, wherein information from a learning map described in claim 9 is used to describe a property line or horizon.

16. A learning map as recited in claim 9 or 13, wherein said cells are assigned a value corresponding to the frequency of swaying of object(s) at that location.

17. A learning map as recited in claim 9 or 13, wherein said cells are assigned a value describing the apparent size of object(s) at that location.

18. A learning map as recited in claim 9 or 13, wherein a plurality of information as described in claim 14, 15, 16 or 17 may be incorporated in a reference learning map.

19. A method for managing motion event notifications and alerts with said security camera comprising the following steps of:
detecting the presence of object(s);
recording presence and motion of said object(s) for a period of time or motion event;
characterizing said object(s) presence and motion(s) in said motion event;
determining if the user is required to further characterize said object(s) in said motion event;
creating a notification of said motion event, if required;
assigning a priority to said notification based on characterizations of object(s) in said motion event, if required;
sending message to the user if no other outstanding messages are present if required; and
placing said notification in a queue based on its assigned priority if required.

20. The method of claim 19 further comprising the following steps of:
the user receiving said message;
the camera sending the highest priority notification to the user;
the user viewing video associated with the motion event and the notification;
the user further characterising observed video from said motion event;
information about said characterization being sent from the user to the camera;
the camera updating reference information based on said characterisation;
the camera re-analyzing outstanding motion events in notification queue;
the camera removing or changing priority of notifications in the queue based on said updated reference information; and
the camera sending the user a message if any outstanding notifications are in the queue.
